(19) United States
(12) Patent Application Publication
(10) Pub. No.: US 2013/0213657 A1
(43) Pub. Date: Aug. 22, 2013

(54) Hybrid Aqueous-Based Suspensions for Hydraulic Fracturing Operations

(71) Applicant: Texas United Chemical Company, LLC, (US)

(72) Inventors: James W. Dobson, JR., Houston, TX (US); Kimberly A. Pierce, Houston, TX (US); Shauna L. Hayden, Houston, TX (US)

(73) Assignee: TEXAS UNITED CHEMICAL COMPANY, LLC, Houston, TX (US)

(21) Appl. No.: 13/774,859

(22) Filed: Feb. 22, 2013

Related U.S. Application Data
(60) Provisional application No. 61/601,967, filed on Feb. 22, 2012.

(51) Int. Cl. C09K 8/86; E21B 43/26; E21B 43/16

(52) U.S. Cl. CPC C09K 8/86; E21B 43/16; E21B 43/26
USPC 166/308.5; 166/305.1; 507/259; 507/262; 507/261; 507/266; 507/238; 507/276; 507/269; 507/240; 507/103; 507/203

(57) ABSTRACT

Disclosed are aqueous-based compositions and methods for treating a subterranean formation for inhibiting formation damage after the treatment. Compositions include an aqueous-based fluid, gelling agents, sparingly-soluble crosslinking agents, and one or more formation damage prevention agents, such as scale inhibitors, iron control agents, non-emulsifiers, clay stabilizers, or polymer breakers. The methods include performing a well treating operation, such as a hydraulic fracturing operation, using the compositions described and inhibiting formation damage, such as scale, iron formation, emulsions, or clay swelling within the subterranean formation. The inclusion of the formation damage preventing agents allows for long-term formation damage inhibition after the treatment.

### CROSS REFERENCE TO RELATED APPLICATIONS

This application claims priority to U.S. Provisional patent application Ser. No. 61/601,967, filed Feb. 22, 2012, the contents of which are incorporated herein by reference in its entirety.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to well treatment fluid compositions and methods, and are more specifically related to compositions, systems and methods for controlling crosslinking reaction times and preventing formation damage in subterranean wells during and after well treatment operations.

2. Description of the Related Art

Aqueous-based fracturing fluids for hydrocarbon recovery operations are typically formulated with an inhibitive brine and chemical additives which serve two purposes, 1) to enhance fracture creation and proppant carrying capabilities, and 2) to minimize formation damage. Components that assist in fracture creation include viscosifying polymers, crosslinking agents, proppants, friction reducers, temperature stabilizers, pH buffers, biocides, fluid loss control additives, and oxygen control additives. Formation damage is addressed with additives such as scale inhibitors, iron control agents, non-emulsifiers, clay stabilizers, and polymer breakers for problems such as clean-up of the proppant pack, clay swelling, precipitation of solids, migration of fines, scale from injection and formation water incompatibility, oil/water emulsions, and water blocks.

Compatibility of components in these complex multi-additive formulations is critical, and combinations of these components into a single additive composition or mixture to reduce the total number of chemicals utilized in a fracturing fluid system is desirable from technical, operational, and economic standpoints.

The aqueous-based sparingly-soluble borate suspensions in U.S. Pat. Nos. 6,936,575, 7,018,956, and U.S. Patent Application Publication No. 2010/0048429 A1 present compositions and methods for the controlled crosslinking of organic polymer in an aqueous solution such as a fracturing fluid. The base water of the suspension provides both a medium to suspend the sparingly-soluble borate crosslinking agent used to enhance proppant carrying capability, and a miscible solution for additional chemical additives to prevent formation damage.

The inventions disclosed and taught herein are directed to hybrid, aqueous-based well treating fluids, such as well stimulation and completion (treatment) fluid compositions containing sparingly-soluble inorganic crosslinking agents and additives active in preventing damage to a subterranean formation.

### BRIEF SUMMARY OF THE INVENTION

The novel feature of the present disclosure is that the hybrid, aqueous well treating fluids described herein allow for treating subterranean formations with minimal formation damage post-treatment.

In accordance with a first aspect of the present disclosure, a well treatment fluid or suspension for the treatment of a well penetrating a subterranean formation is described, the fluid or suspension comprising an aqueous base fluid, a gelling agent, a sparingly-soluble crosslinking agent, and one or more formation damage control agents. In accordance with aspects of this embodiment, the formation damage control agent is a scale inhibitor, iron control agent, non-emulsifier, clay stabilizer, or polymer breaker.

In accordance with a further aspect of the present disclosure, methods of treating subterranean formations are described, the methods comprising the steps of providing a well treatment fluid or suspension that comprises an aqueous carrier fluid, a sparingly-soluble crosslinking agent, and one or more formation damage control agents; injecting the well treatment fluid or suspension into a subterranean formation; and, retaining the well treatment fluid or suspension within the subterranean formation for a period sufficient to treat the well.

In accordance with yet another aspect of the present disclosure, processes for treating a subterranean formation are described, the processes comprising the steps of supplying, via a well bore to a subterranean location, an aqueous oilfield fluid or suspension comprising an aqueous, viscosifying crosslinked reaction product of a polymer and a crosslinking agent, in combination with one or more formation damage control agents; and, exposing the fluid or suspension to conditions at the subterranean location that introduce the formation damage control agent to the formation and thereby reduce damage to the formation during hydrocarbon recovery operations.

In accordance with further aspects of the present disclosure, methods for inhibiting scale in an aqueous oil or gas production system are described, the method comprising the steps of preparing an aqueous oilfield fluid system comprising an aqueous-based fluid or suspension and a viscosifying agent, and a boron-containing crosslinking agent having a solubility ranging from 0.01 kg/m³ to about 10 kg/m³; adding to the aqueous oilfield system a scale inhibitor in an amount effective to inhibit the formation of calcium, barium, or strontium based scale to generate an aqueous scale inhibitor system; and injecting the aqueous scale inhibitor system into a hydrocarbon producing well or subterranean reservoir; wherein the scale inhibition in the aqueous system is maintained at a percent inhibition greater than about 55%.

In accordance with another embodiment of the present disclosure, methods for preventing the deposition of scale on a surface exposed to a hydrocarbon recovery process fluid in a hydrocarbon recovery operation using aqueous-based recovery process fluids are described, the method comprising the steps of supplying via a well bore to a subterranean location, an aqueous oilfield fluid or suspension comprising an aqueous, viscosifying crosslinked reaction product of a polymer and a crosslinking agent, in combination with one or more scale inhibitors; wherein the scale inhibitor prevents deposition of scale comprising calcium or bariums salts on the surface exposed to the process fluid.

### BRIEF DESCRIPTION OF THE SEVERAL VIEWS OF THE DRAWINGS

The following Figures form part of the present specification and are included to further demonstrate certain aspects of the present invention. The invention may be better understood by reference to one or more of these Figures in combination with the detailed description of specific embodiments presented herein.

FIG. 1 illustrates a side view of a calcium carbonate precipitation test in accordance with aspects of the present disclosure.

FIG. 2 illustrates a top view of the calcium brine, carbonate brine, and calcium carbonate precipitate of FIG. 1.

FIG. 3 illustrates a top view of the filtered calcium brine and carbonate brine with a crosslinking additive containing scale inhibitor of FIG. 1, in accordance with the present disclosure.

FIG. 4 illustrates a side view of a calcium sulfate precipitation test in accordance with aspects of the present disclosure.

FIG. 5 illustrates a top view of the calcium brine, sulfate brine, and calcium sulfate precipitate of FIG. 4.

FIG. 6 illustrates a top view of the filtered calcium brine and sulfate brine with a crosslinking additive containing scale inhibitor of FIG. 4, in accordance with the present disclosure.

FIG. 7 illustrates a side view of a calcium carbonate precipitation test in accordance with aspects of the present disclosure, wherein the filtered crosslinking additive contains scale inhibitor, non-emulsifier, and an iron control agent.

FIG. 8 illustrates a top view of the calcium brine, carbonate brine, and calcium carbonate precipitate of FIG. 7.

FIG. 9 illustrates a top view of the filtered calcium brine and carbonate brine with a crosslinking additive containing scale inhibitor, non-emulsifier, and iron control agent of FIG. 7, in accordance with the present disclosure.

FIG. 10 illustrates a side view of a calcium sulfate precipitation test in accordance with aspects of the present disclosure, wherein the filtered crosslinking additive contains scale inhibitor, non-emulsifier, and an iron control agent.

FIG. 11 illustrates a top view of the calcium brine, sulfate brine, and calcium sulfate precipitate of FIG. 10.

FIG. 12 illustrates a top view of the filtered calcium brine and sulfate brine with a crosslinking additive containing scale inhibitor, non-emulsifier, and iron control agent of FIG. 10, in accordance with the present disclosure.

FIG. 13 illustrates a non-emulsifier test in accordance with the present disclosure in brine (25 mL)/diesel (75 mL), using a filtered brine with a crosslinking additive containing a scale inhibitor, non-emulsifier, and iron control agent, in accordance with aspects of the present disclosure, the image being taken at 4 minutes, 57 seconds.

FIG. 14 illustrates a non-emulsifier test in accordance with the present disclosure in brine (50 mL)/diesel (50 mL), using a filtered brine with a crosslinking additive containing a scale inhibitor, non-emulsifier, and iron control agent, in accordance with aspects of the present disclosure, the image being taken at 5 minutes, 54 seconds.

FIG. 15 illustrates a non-emulsifier test in accordance with the present disclosure in brine (75 mL)/diesel (25 mL), using a filtered brine with a crosslinking additive containing a scale inhibitor, non-emulsifier, and iron control agent, in accordance with aspects of the present disclosure, the image being taken at 4 minutes, 19 seconds.

FIG. 16 illustrates the results of an iron-control test for 0.04 grams of ferrous sulfate in 100 mL of distilled water.

FIG. 17 illustrates the results of an iron-control test for a filtered brine with a crosslinking additive containing a scale inhibitor, non-emulsifier, and an iron control agent, in accordance with aspects of the present disclosure.

The Figures and detailed descriptions of these specific embodiments are not intended to limit the breadth or scope of the inventive concepts or the appended claims in any manner. Rather, the Figures and detailed written descriptions are provided to illustrate the inventive concepts to a person of ordinary skill in the art and to enable such person to make and use the inventive concepts.

### DEFINITIONS

The following definitions are provided in order to aid those skilled in the art in understanding the detailed description of the present invention.

The term “alkyl” as used herein, alone or in combination, unless otherwise specified, means a saturated straight or branched primary, secondary, or tertiary hydrocarbon from 1 to 16 carbon atoms, including, but not limited to methyl, ethyl, propyl, isopropyl, butyl, isobutyl, t-butyl, and sec-butyl. The alkyl group may be optionally substituted where possible with any moiety that does not otherwise interfere with the activity or specific reactivity of the overall compound as set out within the present disclosure, including but not limited to halo, haloalkyl, hydroxyl, carboxyl, acyl, aryl, acyloxy, amino, amido, carboxyl derivatives, alkylamino, dialkylamino, arylamino, alkoxy, aryloxy, nitro, cyano, sulfonic acid, thiol, imine, sulfonyl, sulfanyl, sulfinyl, sulfamonyl, ester, carboxylic acid, amide, phosphonyl, phosphinyl, phosphoryl, phosphine, thioester, thioether, acid halide, anhydride, oxime, hydrozine, carbamate, phosphonic acid, phosphonate, either unprotected, or protected as necessary, as known to those skilled in the art.

Whenever a range is referred to herein, it includes independently and separately every member of the range. As a non-limiting example, the term “C₁-C₁₀ alkyl” (or C₁₋₁₀ alkyl) is considered to include, independently, each member of the group, such that, for example, C₁-C₁₀ alkyl includes straight, branched and, where appropriate, cyclic C₁, C₂, C₃, C₄, C₅, C₆, C₇, C₈, C₉ and C₁₀ alkyl functionalities.

In the text, whenever the term “C(alkyl range)” is used, the term independently includes each member of that class as if specifically and separately set out. As a non-limiting example, the term “C₁₋₁₀” independently represents each species that falls within the scope, including, but not limited to, methyl, ethyl, propyl, isopropyl, butyl, sec-butyl, iso-butyl, tert-butyl, pentyl, iso-pentyl, neo-pentyl, cyclopentyl, cyclopentyl, hexyl, 1-methylpentyl, 2-methylpentyl, 3-methylpentyl, 4-methylpentyl, 1-ethylbutyl, 2-ethylbutyl, 3-ethylbutyl, 4-ethyl butyl, cyclohexyl, heptyl, 1-methylhexyl, 2-methylhexyl, 3-methylhexyl, 4-methylhexyl, 5-methylhexyl, 6-methylhexyl, 1-ethylpentyl, 2-ethylpentyl, 3-ethylpentyl, 4-ethylpentyl, 5-ethylpenyl, 1-propylbutyl, 2-propylbutyl, 3-propybutyl, 4-propylbutyl, cycloheptyl, octyl, 1-methylheptyl, 2-methylheptyl, 3-methylheptyl, 4-methylheptyl, 5-methylheptyl, 6-methylheptyl, 7-methylheptyl, 1-ethylhexyl, 2-ethylhexyl, 3-ethylhexyl, 4-ethylhexyl, 5-ethylhexyl, 6-ethylhextyl, 1-propylpentyl, 2-propylpentyl, 3-propypentyl, 4-propylpentyl, 5-propylpentyl, cyclooctyl, nonyl, cyclononyl, decyl, or cyclodecyl.

The term “alkenyl” as used herein, alone or in combination, means a non-cyclic alkyl of 2 to 10 carbon atoms having one or more unsaturated carbon-carbon bonds. The alkenyl group may be optionally substituted where possible with any moiety that does not otherwise interfere with the activity or specific reactivity of the overall compound as set out within the present disclosure, including but not limited to halo, haloalkyl, hydroxyl, carboxyl, acyl, aryl, acyloxy, amino, amido, carboxyl derivatives, alkylamino, dialkylamino, arylamino, alkoxy, aryloxy, nitro, cyano, sulfonic acid, thiol, imine, sulfonyl, sulfanyl, sulfinyl, sulfamonyl, ester, carboxylic acid, amide, phosphonyl, phosphinyl, phosphoryl, phosphine, thioester, thioether, acid halide, anhydride, oxime, hydrozine, carbamate, phosphonic acid, phosphonate, either unprotected, or protected as necessary, as known to those skilled in the art.

The term “alkynyl” as used herein, alone or in combination, means a non-cyclic alkyl of 2 to 10 carbon atoms having one or more triple carbon-carbon bonds, including but not limited to ethynyl and propynyl. The alkynyl group may be optionally substituted where possible with any moiety that does not otherwise interfere with the activity or specific reactivity of the overall compound as set out within the present disclosure, including but not limited to halo, haloalkyl, hydroxyl, carboxyl, acyl, aryl, acyloxy, amino, amido, carboxyl derivatives, alkylamino, dialkylamino, arylamino, alkoxy, aryloxy, nitro, cyano, sulfonic acid, thiol, imine, sulfonyl, sulfanyl, sulfinyl, sulfamonyl, ester, carboxylic acid, amide, phosphonyl, phosphinyl, phosphoryl, phosphine, thioester, thioether, acid halide, anhydride, oxime, hydrozine, carbamate, phosphonic acid, phosphonate, either unprotected, or protected as necessary, as known to those skilled in the art.

The term “aryl” as used herein, alone or in combination, means a carbocyclic aromatic system containing one, two or three rings wherein such rings may be attached together in a pendent manner or may be fused. The “aryl” group can be optionally substituted where possible with one or more of the moieties selected from the group consisting of alkyl, alkenyl, alkynyl, heteroaryl, heterocyclic, carbocycle, alkoxy, oxo, aryloxy, arylalkoxy, cycloalkyl, tetrazolyl, heteroaryloxy; heteroarylalkoxy, carbohydrate, amino acid, amino acid esters, amino acid amides, alditol, halogen, haloalkylthi, haloalkoxy, haloalkyl, hydroxyl, carboxyl, acyl, acyloxy, amino, aminoalkyl, aminoacyl, amido, alkylamino, dialkylamino, arylamino, nitro, cyano, thiol, imide, sulfonic acid, sulfate, sulfonate, sulfonyl, alkylsulfonyl, aminosulfonyl, alkylsulfonylamino, haloalkylsulfonyl, sulfanyl, sulfinyl, sulfamoyl, carboxylic ester, carboxylic acid, amide, phosphonyl, phosphinyl, phosphoryl, thioester, thioether, oxime, hydrazine, carbamate, phosphonic acid, phosphate, phosphonate, phosphinate, sulfonamido, carboxamido, hydroxamic acid, sulfonylimide or any other desired functional group that does not inhibit the desired activity of this compound in association with this disclosure, either unprotected, or protected as necessary, as known to those skilled in the art. In addition, adjacent groups on an “aryl” ring may combine to form a 5- to 7-membered saturated or partially unsaturated carbocyclic, aryl, heteroaryl or heterocyclic ring, which in turn may be substituted as above.

The term “acyl” as used herein, alone or in combination, means a group of the formula —C(O)R′, wherein R′ is alkyl, alkenyl, alkynyl, aryl, or aralkyl group.

The terms “carboxy”, “COOH”, “CO₂H”, and “C(O)OH” are used interchangeably within the present disclosure.

The terms “halo”, “halogen” and “halide” as used herein, alone or in combination, means chloro, bromo, iodo and fluoro.

The term “amino” as used herein, alone or in combination, means a group of the formula NR′R″, wherein R′ and R″ are independently selected from a group consisting of a bond, hydrogen, alkyl, aryl, alkaryl, and aralkyl, wherein said alkyl, aryl, alkaryl and aralkyl may be optionally substituted where possible as defined above.

The term “nitro”, alone or in combination, denotes the radical —NO₂.

The term “substituted” as used herein means that one or more hydrogen on the designated atom or substituent is replaced with a selection from the indicated group, provided that the designated atom's normal valency is not exceeded, and the that the substitution results in a stable compound. When a substitutent is “oxo” (keto) (i.e., ═O), then 2 hydrogens on the atom are replaced. If the term is used without an indicating group, an appropriate substituent known by those skilled in art may be substituted, including, but not limited to, hydroxyl, alkyl, alkenyl, acyl, nitro, protected amino, halo, protected carboxy, epoxide, and cyano.

The term “suspension”, as used herein, refers to a mixture containing a substantially uniform mixture or distribution of solute and particulate matter throughout the liquid carrier; or a mixture containing a solid as a dispersed phase in a liquid phase.

It must be noted that, as used in this specification and the appended claims, the singular forms “a”, “an” and “the” include plural referents unless the content clearly dictates otherwise. Thus, for example, reference to “a salt” can include a mixture of two or more such agents, and the like.

### DETAILED DESCRIPTION

The written description of specific structures and functions below are not presented to limit the scope of what Applicants have invented or the scope of the appended claims. Rather, the written description is provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Applicants have created hybrid, aqueous-based fluids and suspensions which include sparingly-soluble crosslinking agents to enhance the proppant carrying capability of the fluid as appropriate, as well as miscible solutions for including one or more chemical additives that act to prevent damage to a subterranean formation, while simultaneously providing consistent, reproducible crosslink times, maximized gel structure, a compatibility of chemical additives, and an overall simplified well treatment fluid.

Methods of Carrying Out the Invention.

Before describing the present invention in detail, it is to be understood that this invention is not limited to particular formulations or process parameters as such may, of course, vary. It is also to be understood that the terminology used herein is for the purpose of describing particular embodiments of the invention only, and is not intended to be limiting.

Although a number of methods and materials similar or equivalent to those described herein can be used in the practice of the present invention, the preferred materials and methods are described herein.

General Overview.

Embodiments of the invention provide well treatment fluid compositions and methods of using the fluid compositions to treat subterranean formations. The well treatment fluid compositions can be used in hydraulic fracturing, gravel packing operations, water blocking, temporary plugs for purposes of well bore isolation and/or fluid loss control and other well completion operations. The well treatment fluids described within this disclosure are aqueous, whereas non-aqueous fluids are typically formulated and used for these purposes in the industry, and are becoming increasingly undesirable due to global environmental regulations.

The well treatment fluid compositions within the inclusion of the present disclosure, comprise a solvent (preferably water or other suitable aqueous fluid), a hydratable polymer, a crosslinking agent, and one or more of the following formation damage control agents: scale inhibitors, iron control agents, non-emulsifiers, clay stabilizers, and polymer breakers. Optionally, the well treatment fluid composition of the present disclosure may further include various other fluid additives, including but not limited to, friction reducers, temperature stabilizers, pH buffers, biocides, fluid loss control additives, and oxygen control additives, singly or in combination. The well treatment fluid composition may also contain one or more salts, such as potassium chloride, magnesium chloride, sodium chloride, calcium chloride, tetramethyl ammonium chloride, and mixtures thereof, thereby classifying the well treatment fluid as including a “brine.” It has been found that a well treatment fluid made in accordance with embodiments of the present disclosure exhibits reduced or minimized scale precipitation, iron formation, and emulsions.

The water utilized as a solvent or base fluid for preparing the well treatment fluid compositions described herein can be fresh water, unsaturated salt water including brines and seawater, and saturated salt water, and are referred to generally herein as “aqueous-based fluids.” The aqueous-based fluids of the well treatment fluids of the present invention generally comprise fresh water, salt water, sea water, a brine (e.g., a saturated salt water or formation brine), or a combination thereof. Other water sources may be used, including those comprising monovalent, divalent, or trivalent cations (e.g., magnesium, calcium, zinc, or iron) and, where used, may be of any weight.

In certain exemplary embodiments of the present inventions, the aqueous-, based fluid may comprise fresh water or salt water depending upon the particular density of the composition required. The term “salt water” as used herein may include unsaturated salt water or saturated salt water “brine systems” that are made up of at least one water-soluble salt of a multivalent metal, including single salt systems such as a NaCl, NaBr, MgCl₂, KBr, or KCl brines, as well as heavy brines (brines having a density from about 8 ppg to about 20 ppg), including but not limited to single-salt systems, such as brines comprising water and CaCl₂, CaBr₂, zinc salts including, but not limited to, zinc chloride, zinc bromide, zinc iodide, zinc sulfate, and mixtures thereof, with zinc chloride and zinc bromide being preferred due to low cost and ready availability; and, multiple salt systems, such as NaCl/CaCl₂ brines, CaCl₂/CaBr₂ brines, CaBr₂/ZnBr₂ brines, and CaCl₂/CaBr₂/ZnBr₂ brines. If heavy brines are used, such heavy brines will preferably have densities ranging from about 12 ppg to about 19.5 ppg (inclusive), and more preferably, such a heavy brine will have a density ranging from about 16 ppg to about 19.5 ppg, inclusive.

The brine systems suitable for use herein may comprise from about 1% to about 75% by weight of one or more appropriate salts, including about 3 wt. %, about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, and about 75 wt. % salt, without limitation, as well as concentrations falling between any two of these values, such as from about 21 wt. % to about 66 wt. % salt, inclusive. Generally speaking, the aqueous-based fluid used in the treatment fluids described herein will be present in the well treatment fluid in an amount in the range of from about 2% to about 99.5% by weight. In other exemplary embodiments, the base fluid may be present in the well treatment fluid in an amount in the range of from about 70% to about 99% by weight. Depending upon the desired viscosity of the treatment fluid, more or less of the base fluid may be included, as appropriate. One of ordinary skill in the art, with the benefit of this disclosure, will recognize an appropriate base fluid and the appropriate amount to use for a chosen application.

If a water source is used that contains such divalent or trivalent cations in concentrations sufficiently high to be problematic, then such divalent or trivalent salts may be removed, either by a process such as reverse osmosis, or by raising the pH of the water in order to precipitate out such divalent salts to lower the concentration of such salts in the water before the water is used. Another method would be to include a chelating agent to chemically bind the problematic ions to prevent their undesirable interactions with the water-hydratable polymer. Suitable chelants, or chelating agents, suitable for use with the compositions described herein include, but are not limited to, citric acid or sodium citrate, ethylenediamine tetraacetic acid (“EDTA”), hydroxyethyl ethylenediamine triacetic acid (“HEDTA”), dicarboxymethyl glutamic acid tetrasodium salt (“GLDA”), diethylenetriamine pentaacetic acid (“DTPA”), propylenediaminetetraacetic acid (“PDTA”), ethylenediaminedi-(o-hydroxyphenylacetic) acid (“EDDHA”), glucoheptonic acid, gluconic acid, and the like, and nitrilotriacetic acid (“NTA”). Other chelants or chelating agents also may be suitable for use herein. One skilled in the art will readily recognize that an aqueous-based fluid containing a high level of multivalent ions should be tested for compatibility prior to use.

The well treatment fluids of the present invention and/or any component thereof may be prepared at a job site, or they may be prepared at a plant or facility prior to use, and may be stored for some period of time prior to use. In certain embodiments of the present disclosure, the preparation of these well treatment fluids of the present invention may be done at the job site in a method characterized as being performed “on the fly.” The term “on-the-fly” as used herein is meant to include methods of combining two or more components wherein a flowing stream of one element is continuously introduced into a flowing stream of another component so that the streams are combined and mixed while continuing to flow as a single stream as part of the on-going treatment. Such mixing can also, and equivalently, be described as “real-time” mixing. These streams also may be held for a period of time, among other purposes, to facilitate polymer hydration prior to injection into the subterranean formation.

General Fluid Components.

Viscosifying Agent.

The aqueous well treatment fluids of the present disclosure preferably include a gelling additive, also known as a gelling agent, viscosifying agent, or viscosifying polymer. As used herein, the terms “gelling agent” or “viscosifying agent” refer equivalently to a material capable of forming the well treatment fluid into a gel, thereby increasing its viscosity. The amount of the viscosifying agent present in the well treatment fluids described herein preferably ranges from about 0.295% to about 0.47% by weight of the water in the treatment fluid. Examples of suitable viscosifying, or gelling, additives include, but are not limited to, natural or derivatized polysaccharides that are soluble, dispersible, or swellable in an aqueous liquid, modified celluloses and derivatives thereof, and biopolymers. Examples of polysaccharides include but are not limited to: galactomannan gums such as gum ghatti, gum karaya, tamarind gum, tragacanth gum, guar gum, and locust bean gum; modified gums such as carboxyalkyl derivatives, e.g., carboxymethylguar, and hydroxyalkyl derivatives, e.g., hydroxypropylguar; and double derivatized gums such as carboxymethylhydroxypropylguar. Examples of water-soluble cellulose ethers include carboxymethylcellulose (CMC), hydroxyethylcellulose, methylhydroxypropylcellulose, and carboxymethylhydroxyethylcelluose. Non-limiting examples of biopolymers include xanthan gum, welan gum, and diutan gum.

Examples of other suitable viscosifying agents include, but are not limited to, water dispersible hydrophilic organic polymers having molecular weights ranging from about 1 to about 10,000,000 such as polyacrylamide and polymethacrylamide, wherein about 5% to about 7.5% are hydrolyzed to carboxyl groups and a copolymer of about 5% to about 70% by weight acrylic acid or methacrylic acid copolymerized with acrylamide or methacrylamide.

Examples of additional suitable viscosifying agents include, but are not limited to, water-soluble polymers such as a terpolymer of an ethylenically unsaturated polar monomer, an ethylenically unsaturated ester, and a monomer selected from acrylamido-2-methylpropane sulfonic (AMPS) acid or N-vinylpyrrolidone; and a terpolymer of an ethylenically unsaturated polar monomer, an ethylenically unsaturated ester, AMPS acid, and N-vinylpyrrolidone. Other suitable gelling additives are polymerizable water-soluble monomers, such as acrylic acid, methacrylic acid, acrylamide, and methacrylamide.

Of the foregoing gelling additives, galactomannans, cellulose derivatives, and biopolymers are preferred. Preferred galactomannans are guar, hydroxypropylguar, and carboxymethylhydroxypropylguar. Preferred cellulose derivatives are hydroxyethylcellulose, carboxymethylhydroxyethylcellulose, and hydroxyethylcellulose. Of the foregoing described biopolymers, xanthan gum is preferred. The amount of xanthan gum present in the well treatment fluid, when it is used as a viscosifying agent, is preferably in the range of from about 10 pounds (lbs)/1,000 gallons (gal) (pounds per thousand gallons, pptg) to about 55 pounds (lbs)/1,000 gallons (gal) of fracturing fluid, inclusive. Additional disclosure regarding the foregoing gelling additives can be found in U.S. Patent Publication No. 2010/0048429 A1, which is incorporated by reference herein in its entirety.

The typical crosslinkable organic polymers, sometimes referred to equivalently herein as “gelling agents” or “viscosifying agents”, that may be included in the treatment fluids and systems described herein, particularly aqueous fluids and systems, and that may be used in connection with the presently disclosed inventions, typically comprise biopolymers, synthetic polymers, or a combination thereof, wherein the “gelling agents” or crosslinkable organic polymers are at least slightly soluble in water (wherein slightly soluble means having a solubility of at least about 0.01 kg/m³). Without limitation, these crosslinkable organic polymers may serve to increase the viscosity of the treatment fluid during application. A variety of gelling agents can be used in conjunction with the methods and compositions of the present inventions, including, but not limited to, hydratable polymers that contain one or more functional groups such as hydroxyl, cis-hydroxyl, carboxylic acids, derivatives of carboxylic acids, sulfate, sulfonate, phosphate, phosphonate, amino, or amide. The gelling agents may also be biopolymers comprising natural, modified and derivatized polysaccharides, and derivatives thereof that contain one or more of the monosaccharide units selected from the group consisting of galactose, mannose, glucoside, glucose, xylose, arabinose, fructose, glucuronic acid, or pyranosyl sulfate. Suitable gelling agents which may be used in accordance with the present disclosure include, but are not limited to, guar; hydroxypropyl guar (HPG); cellulose, carboxymethyl cellulose (CMC); carboxymethyl hydroxyethyl cellulose (CMHEC); hydroxyethyl cellulose (HEC), carboxymethylhydroxypropyl guar (CMHPG); other derivatives of guar gum; xanthan; galactomannan gums and gums comprising galactomannans; cellulose and other cellulose derivatives, derivatives thereof; and combinations thereof, such as various carboxyalkyl cellulose ethers, such as carboxyethyl cellulose; mixed ethers such as carboxyalkylethers; hydroxyalkyl celluloses such as hydroxypropyl cellulose; alkylhydroxyalkylcelluloses such as methylhydroxypropyl cellulose; alkylcelluloses such as methyl cellulose, ethyl cellulose and propyl cellulose; alkylcarboxyalkylcelluloses such as ethylcarboxymethyl cellulose; alkylalkylcelluloses such as methylethyl cellulose; hydroxyalkylalkylcelluloses such as hydroxypropylmethyl cellulose; combinations thereof, and the like. Preferably, in accordance with one non-limiting embodiment of the present disclosure, the gelling or viscosifying agent is guar, cellulose, hydroxypropyl guar (HPG), or carboxymethylhydroxypropyl guar (CMHPG), alone or in combination.

Additional natural polymers suitable for use as crosslinkable organic polymers/gelling agents in accordance with the present disclosure include, but are not limited to, locust bean gum, tara (Cesalpinia spinosa lin) gum, konjac (Amorphophallus konjac) gum, starch, cellulose, karaya gum, xanthan gum, tragacanth gum, arabic gum, ghatti gum, tamarind gum, carrageenan and derivatives thereof. Additionally, synthetic polymers and copolymers that contain any of the above-mentioned functional groups may also be used. Examples of suitable synthetic polymers include, but are not limited to, polyacrylate, polymethacrylate, polyacrylamide, polyvinyl alcohol, maleic anhydride, methylvinyl ether copolymers, and polyvinylpyrrolidone.

Generally speaking, the amount of a gelling agent/crosslinkable organic polymer that may be included in a treatment fluid for use in conjunction with the present inventions depends on the viscosity desired. Thus, the amount to include will be an amount effective to achieve a desired viscosity effect. In certain exemplary embodiments of the present inventions, the gelling agent may be present in the treatment fluid in an amount in the range of from about 0.1% to about 60% by weight of the treatment fluid. In other exemplary embodiments, the gelling agent may be present in the range of from about 0.1% to about 20% by weight of the treatment fluid. In general, however, the amount of crosslinkable organic polymer included in the well treatment fluids described herein is not particularly critical so long as the viscosity of the fluid is sufficiently high to keep the proppant particles or other additives suspended therein during the fluid injecting step into the subterranean formation. Thus, depending on the specific application of the treatment fluid, the crosslinkable organic polymer may be added to the aqueous-based fluid in concentrations ranging from about 15 to 60 pounds per thousand gallons (lb/1,000 gal) by volume of the total aqueous fluid (1.8 to 7.2 kg/m³). In a further non-limiting range for the present inventions, the concentration may range from about 20 lb/1,000 gal (2.4 kg/m³) to about 40 lb/1,000 gal (4.8 kg/m³). In further, non-restrictive aspects of the present disclosure, the crosslinkable organic polymer/gelling agent present in the aqueous-based fluid may range from about 25 lb/1,000 gal (about 3 kg/m³) to about 40 lb/1,000 gal (about 4.8 kg/m³) of total fluid. One skilled in the art, with the benefit of this disclosure, will recognize the appropriate gelling agent and amount of the gelling agent to use for a particular application. Preferably, in accordance with one aspect of the present disclosure, the fluid composition or well treatment system will contain from about 1.2 kg/m³ (0.075 lb/ft³) to about 12 kg/m³ (0.75 lb/ft³) of the gelling agent/crosslinkable organic polymer, most preferably from about 2.4 kg/m³ (0.15 lb/ft³) to about 7.2 kg/m³ (0.45 lb/ft³).

Crosslinking Agents.

In order to increase the viscosity of the treating fluids of the present disclosure, a crosslinking agent is mixed with the aqueous-based fluid to crosslink the organic polymer and create a viscosified treatment fluid. The crosslinking agent utilized in the treating fluids described herein is preferably selected from the group consisting of boron compounds such as, for example, boric acid, disodium octaborate tetrahydrate, sodium diborate and pentaborates, and naturally occurring compounds that can provide boron ions for crosslinking, such as ulexite and colemanite; compounds which can supply zirconium IV ions such as, for example, zirconium lactate, zirconium lactate triethanolamine, zirconium carbonate, zirconium acetylacetonate and zirconium diisopropylamine lactate; compounds that can supply titanium IV ions such as, for example, titanium ammonium lactate, titanium triethanolamine, titanium acetylacetonate; compounds that can supply aluminum ions such as, for example, aluminum lactate or aluminum citrate; or, compounds that can supply antimony ions. Of these, a borate compound, particularly a sparingly-soluble borate, is the most preferred. The crosslinking agent utilized is included in the treating fluids described herein in an amount in the range of from about 200 ppm to about 4,000 ppm, inclusive.

As indicated, in accordance with select aspects of the present disclosure, the crosslinking agent is preferably a borate, more particularly a sparingly-soluble borate. For the purposes of the present disclosure, the term “sparingly-soluble” is defined as having a solubility in water at 22° C. (71.6° F.) of less than about 10 kg/m³, as may be determined using procedures known in the arts such as those described by Guilensoy, et al. [M. T. A. Bull., no. 86, pp. 77-94 (1976); M.T.A. Bull., no. 87, pp. 36-47 (1978)]. For example, and without limitation, sparingly-soluble borates having a solubility in water at 22° C. (71.6° F.) ranging from about 0.1 kg/m³ to about 10 kg/m³ are appropriate for use in the compositions disclosed herein. Generally, in accordance with the present disclosure, the sparingly-soluble borate crosslinking agent may be any material that supplies and/or releases borate ions in solution. Exemplary sparingly-soluble borates suitable for use as crosslinking agents in the treating fluid compositions in accordance with the present disclosure include, but are not limited to, boric acid, alkali metal, alkali metal-alkaline earth metal borates, and the alkaline earth metal borates such as disodium octaborate tetrahydrate, sodium diborate, as well as boron containing minerals and ores. In accordance with certain aspects of the present disclosure, the concentration of the sparingly-soluble borate crosslinking agent described herein ranges from about from about 0.01 kg/m³ to about 10 kg/m³, preferably from about 0.1 kg/m³ to about 5 kg/m³, and more preferably from about 0.15 kg/m³ to about 2.5 kg/m³ in the well treatment fluid.

Boron-containing minerals suitable for use as sparingly-soluble borate crosslinking agent in accordance with the present disclosure are those ores containing 5 wt. % or more boron, including both naturally-occurring and synthetic boron-containing minerals and ores. Exemplary naturally-occurring, boron-containing minerals and ores suitable for use herein include but are not limited to boron oxide (B₂O₃), boric acid (H₃BO₃), borax (Na₂B₄O₇-10H₂O), colemanite (Ca₂B₆O₁₁-5H₂O), frolovite (Ca₂B₄O₈-7H₂O), ginorite (Ca₂B₁₄O₂₃-8H₂O), gowerite (CaB₆O₁₀-5H₂O), howlite (Ca₄B₁₀O₂₃Si₂-5H₂O), hydroboracite (CaMgB₆O₁₁-6H₂O), inderborite (CaMgB₆O₁₁-11H₂O), inderite (Mg₂B₆O₁₁-15H₂O), inyoite (Ca₂B₆O₁₁-13H₂O), kaliborite (Heintzite) (KMg₂B₁₁O₁₉-9H₂O), kernite (rasorite) (Na₂B₄O₇-4H₂O), kumakovite (MgB₃O₃(OH)₅-15H₂O), meyerhofferite (Ca₂B₆O₁₁-7H₂O), nobleite (CaB₆O₁₀-4H₂O), pandermite (Ca₄B₁₀O₁₉-7H₂O), patemoite (MgB₂O₃-4H₂O), pinnoite (MgB₂O₄-3H₂O), priceite (Ca₄B₁₀O₁₉-7H₂O), preobrazhenskite (Mg₃B₁₀O₁₅-4.5H₂O), probertite (NaCaB₅O₉-5H₂O), tertschite (Ca₄B₁₀O₁₉-20H₂O), tincalconite (Na₂B₄O₇-5H₂O), tunellite (SrB₆O₁₀-4H₂O), ulexite (Na₂Ca₂B₁₀O₁₅-16H₂O), and veatchite (Sr₄B₂₂O₃₇-7H₂O), as well as any of the Class V-26 Dana Classification borates, hydrated borates containing hydroxyl or halogen, as described and referenced in Gaines, R. V., et al. [Dana's New Mineralogy, John Wiley & Sons, Inc., NY, (1997)], or the class V/G, V/H, V/J or V/K borates according to the Strunz classification system [Hugo Strunz; Ernest Nickel: Strunz Mineralogical Tables, Ninth Edition, Stuttgart: Schweizerbart, (2001)]. Any of these may be hydrated and have variable amounts of water of hydration, including but not limited to tetrahydrates, hemihydrates, sesquihydrates, and pentahydrates. Further, in accordance with some aspects of the present disclosure, it is preferred that the sparingly-soluble borates be borates containing at least 3 boron atoms per molecule, such as triborates, tetraborates, pentaborates, hexaborates, heptaborates, octaborates, decaborates, and the like. In accordance with one aspect of the present disclosure, the preferred crosslinking agent is a sparingly-soluble borate selected from the group consisting of ulexite, colemanite, probertite, and mixtures thereof, and most preferably, ulexite and/or colemanite.

Proppants.

The well treatment fluids of the present disclosure may also include a particulate proppant material which can be resin coated or uncoated, as appropriate, in accordance with methods known in the art. The particulate proppant material, also referred to herein generally as a proppant, suitable for use with the treatment fluids of the present disclosure includes a variety of particulate materials known to be suitable or potentially suitable propping agents which can be employed in downhole operations. In accordance with the present disclosure, the particulate material (or substrate material) which can be used include any propping agent suitable for hydraulic fracturing known in the art. Examples of such particulate materials include, but are not limited to, natural materials, silica proppants, ceramic proppants, metallic proppants, synthetic organic proppants, mixtures thereof, and the like.

Friction Reducers.

In the petroleum industry, it is an increasingly common practice to perform a procedure known as a “slickwater fracturing” operation. This is a method of stimulating the production of hydrocarbons from a subterranean well by pumping water at high rates into the well, thus creating a fracture in the productive formation. Practical and cost considerations for these treatments require the use of materials to reduce pumping pressure by reducing the frictional drag of the water against the well tubulars. Polyacrylamide polymers are very widely used for this purpose. Consequently, as the compositions described herein may be used for a variety of well treatment operations, including slickwater fracturing, friction reducers may also be incorporated into fluid compositions of the present disclosure. Any friction reducer may be used. Also, polymers such as polyacrylamide, polyisobutyl methacrylate, polymethyl methacrylate and polyisobutylene, as well as water-soluble friction reducers such as guar gum, guar gum derivatives, hydrolyzed polyacrylamide, and polyethylene oxide may be used as friction reducers in accordance with the present disclosure. Exemplary commercial drag reducing chemicals (friction reducers) such as those sold by Conoco Inc. under the CDR™ trademark as described in U.S. Pat. No. 3,692,676, or drag reducers such as a number of commercially available polyalphaolefins. Those polyalphaolefins (PAOs) particularly suitable for use as friction or drag reducers with the processes and compositions of the present disclosure include but are not limited to the FLO™ family of PAO drag reducing agents (DRAs), including FLO 1003™, FLO 1004™, FLO 1005™, FLO 1008™, FLO 1010™, FLO 1012™, FLO 1020™ and FLO 1022™ DRAs sold by Baker Petrolite Corporation, Houston, Tex. It should be noted that these polymeric species added as friction reducers/drag reducing agents or viscosity index improvers may also act as excellent fluid loss additives, thereby reducing or even eliminating the need for conventional fluid loss additives.

In the methods and compositions of this invention, the amount of friction reducer/drag reducing agent in the well treatment composition may range from about 1 wt. % to about 20 wt. %. In accordance with one embodiment, the amount of FR/DRA in the well treatment fluid composition preferably ranges from about 3 wt. % to about 10 wt. %.

Temperature Stabilizers.

In the case of high bottom hole static temperature (>95° C.) situations, one or more high temperature stabilizers may be added to the compositions described herein in order to prevent oxidation or radical reaction, which may in turn reduce fluid viscosity. Such temperature stabilizers must be compatible with other additives in the well treatment compositions described herein, and must also maintain their performance attributes in the aqueous solutions to which they are added. Exemplary temperature stabilizers suitable for use with the compositions of the present disclosure include but are not limited to high-boiling (e.g., having a boiling point (bp) greater than about 60° C.) alcohols and alcohol derivates, such as methanol or isopropanol.

pH Buffers.

The well treating fluid can include one or more buffering compounds for adjusting the pH to an optimum or desired level for crosslinking with the composition of the invention. Examples of such compounds which can be utilized include, but are not limited to, potassium carbonate, potassium hydroxide, sodium hydroxide, sodium phosphate, sodium hydrogen phosphate, boric acid-sodium hydroxide, citric acid-sodium hydroxide, boric acid-borax, sodium bicarbonate, ammonium salts, sodium salts, potassium salts, dibasic phosphate, tribasic phosphate, calcium oxide, magnesium oxide, zinc oxide, or other similar buffering agents, in a amount ranging from 0.1 wt % to about 1 wt %, inclusive. The buffering agents, when included, are effective to provide a pH for the well treating or fracturing fluid system in a range from about pH 8.0 to about pH 12.0.

A pH buffer also can be included in the compositions of the present invention. Examples of suitable pH buffers which can be used include, but are not limited to, sodium carbonate, potassium carbonate, sodium bicarbonate, potassium bicarbonate, sodium or potassium diacetate, sodium or potassium phosphate, sodium or potassium hydrogen phosphate, sodium or potassium dihydrogen phosphate and the like. When used, the buffer is included in the composition in an amount in the range of from about 0.1% to about 10% by weight of the water therein.

Biocides.

In some embodiments of the present disclosure, the well treatment fluids of the present invention may contain biocides, also referred to in the art as “bactericides,” to protect both the subterranean formation as well as the viscosified treatment fluid from attack by bacteria. Such attacks may be problematic because they may lower the viscosity of the treatment fluid, resulting in poor performance, such as inadequate sand suspension properties, for example. Any biocides or bactericides known in the art are suitable. Preferably, the bactericides which can be utilized in accordance with the present invention are any of the various commercially available bactericides which kill anaerobic sulfate reducing and sludge or slime forming bacteria upon contact, and which are compatible with the well treatment fluid utilized and components of the formation into which they are introduced. The term “compatible” is used herein to mean that the bactericide or biocide is stable, does not react with, or adversely affect components of the well treatment fluid or formation and is not neutralized by components in the formation itself. Examples of suitable bactericides suitable for use with the treatment fluids of the present disclosure include, but are not limited to, aldehydes such as glutaraldehyde and glutaric aldehyde; nitro-group (NO₂)-containing compounds such as 2,2-dibromo-3-nitrilopropionamide, commercially available under the trade name BE-3S™ biocide and 2-bromo-2-nitro-1,3-propanediol, both commercially available under the trade name BE-6™ biocide from Halliburton Energy Services, Inc., of Duncan, Okla. (USA); triazines, such as hexahydro-1,3,6-tris(hydroxyethyl)-S-triazine, hexahydro-1,3,5-triethyl-s-triazine; sulfur-containing heterocycles, such as 3,5-dimethyl-1,3,5-thiadiazinane-2-thione (also commonly referred to as “Thione”); sulfates, such as tetrakis-hydroxymethyl phosphonium sulfate; solutions of 5-chloro-2-methyl-4-isothiazolin-3-one and 2-methyl-4-isothiazolin-3-one; alkyl-aryl triethylammonium chloride solution; methylene bis(thiocyanate); 2-methyl-5-nitroimidazole-1-ethanol; as well as combinations of any of the foregoing bactericides. Additional examples of suitable bactericides/biocides for use in the well treatment fluids disclosed herein include sodium hypochlorite/sodium hydroxide admixtures, lithium and calcium hypochlorite, hydrogen peroxide, and the like. In one embodiment, the bactericides are present in the well treatment fluid in an amount in the range of from about 0.001% to about 1.0% by weight, inclusive, of the well treatment fluid. In certain embodiments of the disclosure, when bactericides are used in the well treatment fluids of the present invention, they may be added to the well treatment fluid before the gelling agent is added.

Fluid Loss Control Additives.

Providing effective fluid loss control for subterranean treatment fluids, such as those described herein, is highly desirable. “Fluid loss,” as used herein, refers to the undesirable migration or loss of fluids (such as the fluid portion of a drilling mud or cement slurry) into a subterranean formation and/or a proppant pack. The term “proppant pack,” as used herein, refers to a collection of a mass of proppant particulates within a fracture or open space in a subterranean formation. The “treatment fluids” may comprise any fluids used in a subterranean application, and consequently, the term “treatment” as used within the present disclosure does not imply any particular action by the fluid or any component thereof. Treatment fluids in accordance with the present disclosure may be used in any number of subterranean operations, including drilling operations, fracturing operations (hydraulic, acid, or otherwise), acidizing operations, gravel-packing operations, well bore clean-out operations, and the like. Fluid loss may be problematic in any number of these operations. In fracturing treatments, for example, fluid loss into the formation may result in a reduction in fluid efficiency, such that the fracturing fluid cannot propagate the fracture as desired.

Fluid loss control materials are additives that lower the volume of a filtrate that passes through a filter medium. Certain particulate materials may be used as a fluid loss control materials in subterranean treatment fluids to fill the pore spaces in a formation matrix and/or proppant pack and/or to contact the surface of a formation face and/or proppant pack, thereby forming a filter cake that blocks the pore spaces in the formation or proppant pack, and prevents fluid loss therein. However, the use of certain particulate fluid loss control materials may also be problematic. For instance, the sizes of the particulates may not be optimized for the pore spaces in a particular formation matrix and/or proppant pack and, as a result, may increase the risk of invasion of the particulate material into the interior of the formation matrix, which may greatly increase the difficulty of removal by subsequent remedial treatments. Additionally, once fluid loss control is no longer required, for example, after completing a treatment, remedial treatments may be required to remove the previously-placed fluid loss control materials, inter alia, so that a well may be placed into production. However, particulates that have become lodged in pore spaces and/or pore throats in the formation matrix and/or proppant pack may be difficult and/or costly to remove. Moreover, certain particulate fluid loss control materials may not be effective in low-permeability formations (e.g., formations with a permeability below about 1 millidarcy (“mD”)) since the leak-off rate in those formations is not high enough to pull the particulates into the pore spaces or into contact with the surface of the formation face and/or proppant pack so as to block or seal off the pore spaces therein.

The treatment fluids of the present disclosure may also comprise suitable fluid loss control agents. Such fluid loss control agents may be useful, among other instances, when a treatment fluid of the present invention is being used in a fracturing application. This may be due, in part, to a specific component's potential to leak off into formation. Any fluid loss agent that is compatible with the treatment fluid described herein may be suitable for use in the present disclosure. Examples include, but are not limited to, starches, silica flour, and diesel dispersed in a fluid. Other examples of fluid loss control additives that may be suitable are those that comprise a degradable material. Suitable degradable materials include degradable polymers. Specific examples of suitable polymers include polysaccharides such as dextran or cellulose; chitins; chitosans; proteins; aliphatic polyesters; poly(lactides); poly(glycolides); poly(glycolide-co-lactides); poly(.epsilon.-caprolactones); poly(3-hydroxybutyrates); poly(3-hydroxybutyrate-co-hydroxyvalerates); poly(anhydrides); aliphatic poly(carbonates); poly(orthoesters); poly(amino acids); poly(ethylene oxides); poly(phosphazenes); derivatives thereof; or combinations thereof. If included, a fluid loss additive should be added to a treatment fluid of the present disclosure in an amount ranging from about 5 to about 2,000 pounds per 1,000 gallons of the treatment fluid. In certain embodiments, the fluid loss additive may be included in an amount from about 10 to about 500 pounds per 1,000 gallons of the treatment fluid. For some circumstances, these fluid loss control additives may be included in an amount ranging from about 0.01% to about 20% by volume, inclusive; in some embodiments, these may be included in an amount from about 1% to about 10% by volume, inclusive.

Oxygen Control Additives.

The introduction of water downhole often is accompanied by an increase in the oxygen content of downhole fluids due to oxygen dissolved in the introduced water. Thus, the materials introduced downhole must work in oxygen environments or must work sufficiently well until the oxygen content has been depleted by natural reactions. For system that cannot tolerate oxygen, then oxygen must be removed or controlled in any material introduced into the downhole environment. This problem is exacerbated during the winter or in cold climate operations when the injected materials include winterizers such as water, alcohols, glycols, Cellosolves™, formates, acetates, or the like and because oxygen solubility is higher to a range of about 14-15 ppm in very cold water. Oxygen can also increase corrosion and scaling within the formation or wellbore itself.

Options for controlling oxygen content in the treatment fluids of the present disclosure include, but are not limited to: (1) de-aeration of the treatment fluid prior to downhole injection; (2) addition of normal sulfides to product sulfur oxides, but such sulfur oxides can accelerate acid attack on metal surfaces; (3) addition of erythorbates, ascorbates, diethylhydroxyamine or other oxygen reactive compounds that are added to the fluid prior to downhole injection; and (4) addition of corrosion inhibitors or metal passivation agents such as potassium (alkali) salts of esters of glycols, polyhydric alcohol ethyloxylates or other similar corrosion inhibitors. Exemplary examples oxygen and corrosion inhibiting agents include mixtures of tetramethylene diamines, hexamethylene diamines, 1,2-diaminecyclohexane, amine heads, or reaction products of such amines with partial molar equivalents of aldehydes. Other oxygen control agents suitable for use herein include salicylic and benzoic amides of polyamines, used especially in alkaline conditions, short chain acetylene diols or similar compounds, phosphate esters, borate glycerols, urea and thiourea salts of bisoxalidines or other compound that either absorb oxygen, react with oxygen or otherwise reduce or eliminate oxygen.

Formation Damage Control Additives.

Scale Inhibitors.

Problematic scale deposits and other similar formation damage occurrences can occur in the production of water and hydrocarbons from subterranean formations and can result in plugged well bores, plugged well casing perforations, plugged tubing strings, stuck downhole safety valves as well as other valves located downhole, stuck downhole pumps and other downhole and surface equipment and lines, scaled formations and fractures in the vicinity of the well bore. Another problem with scale formation in large industrial wells is the formation of scale on the equipment used to extract the hydrocarbons from the field, particularly on the interior surfaces of production tubing and at the perforations in the wall of the casing itself. At the well head, the sub-surface safety valve is also susceptible to damage caused by scale formation.

Scale formation can occur as a result of mixing incompatible waters in the well which produce precipitates, or as a result of temperature and pressure changes in the produced waters during production. Generally, incompatible waters occur in waterflooding operations, such as injecting sea water mixes with formation water in the borehole during water breakthrough. More commonly, scale is deposited due to changes in supersaturation or solubility of minerals in the formation or produced waters caused by pressure and temperature changes, or changes in other physical and chemical parameters, such as gas compositions, or the ratio of gas/oil/water. Scale may also be formed from the corrosion of metal equipment used in the production of hydrocarbons from subterranean formations. Precipitation frequently encountered as scale includes calcium carbonate, calcium sulfate, barium sulfate, magnesium carbonate, magnesium sulfate, and strontium sulfate.

When a well bore is initially drilled in an oil field, the oil extracted is usually “dry,” being substantially free of aqueous impurities. However, as the oil reserves dwindle, a progressively greater quantity of aqueous impurities becomes mixed with the oil. Changes in formation physical conditions during the production cycle as well as mixing of incompatible waters (i.e. sea water and barium or strontium containing formation waters) can cause scaling in any part of the production system. Scale that occurs in the production system can result in a significant loss in production and associated revenue.

Scale formation and scale deposits can be reduced by the introduction of inhibitors into a formation through fluid injection. The formation of deposits can be inhibited, and in some case prevented, by the use of chemical compounds referred to as “scale inhibitors.” Scale inhibitors, as used herein, refers to those substances that significantly reduce or inhibit the formation of scale, partly by inhibiting crystallization and/or retarding the growth of scale forming minerals when applied in sub-stoichiometric amounts. Currently, scale is often treated by the addition of sub-stoichiometric levels of water soluble organic scale inhibitors in the 1-500 ppm dosage range. These scale inhibitors are often referred to as threshold scale inhibitors, i.e. there is a threshold dose level below which they do not inhibit scale formation. This limit is often referred to as the minimum inhibitor concentration (MIC).

Various inhibitors of scale formation have been developed over the years, including carboxylated polymers, organophosphates, organophosphonates and polyphosphonates. Typically, carboxylated polymers are polymers and copolymers of acrylic or methacrylic acids, commonly referred to as polyacrylic acids. Organophosphorous-containing inhibitors include alkyl ethoxylated phosphates; ethylenediaminetetramethylene phosphonic acid; aminotrimethylene phosphonic acid; hexamethylenediaminetetramethylene phosphonic acid; d iethylenetriam ine-pentamethylene phosphonic acid; hydroxyethylidenediphosphonic acid and polyvinyl phosphonic acid. The injection of scale inhibitors without pre- or post-crosslinking to protect an oil or gas well from mineral scale formation is widely practiced. However, such treatments often result in poor retention in the subterranean formation, quick depletion and frequent re-treatments, which is costly and time-consuming. Additionally, a number of the scale inhibitors are non-water soluble, requiring the use of oil-based fluids in order to carry them to the affected area of the formation or production system.

One method that has been disclosed to address the issue of retention of scale inhibitors in formations [A. J. Essel and B. L. Carlberg, “Strontium Sulfate Scale Control by Inhibitor Squeeze Treatment in the Fateh Field,” Journal of Petroleum Technology, p. 1303 (June 1982)] describes a method to increase retention of an inhibitor in a subterranean limestone formation by injecting the acid form of a polyphosphonate inhibitor so as to form a slightly soluble calcium salt. Calcium ions released on dissolution of some of the limestone rock by the acid precipitates calcium polyphosphonate allowing greater retention in the rock. However, subsequent to this publication, it has been found that this method does not exhibit good effectiveness in certain geologic rock formations, such as sandstones, because such formations are insoluble in acids, and do not form calcium ions even when dissolved. Other approaches to the problems in dealing with scale formation during hydrocarbon production have been discussed througout the literature [see, “Prediction of Scale Formation Problems in Oil Reservoirs and Production Equipment due to Injection of Incompatible Waters”, J. Moghadasi, et al., in Developments in Chemical Engineering and Mineral Processing, Vol. 14 (3-4), pp. 545-566 (2006); SPE 10595 (1982); SPE 7861 (1979); Journal of Petroleum Technology, August 1969, Ralston, P. H., “Scale Control with aminomethylene-phosphonates”; and, “Standard Handbook of Petroleum and Natural Gas Engineering, Vol. 2”, William C. Lyons, ed.].

Another problem with conventional techniques of treatment derives from the fact that aqueous solutions are usually more dense than the crude oil in the field. Consequently, once an aqueous solution of oil scale inhibitor has been used to treat a well, there is insufficient pressure support in the field for the well to flow naturally after treatment has finished. Consequently, the well must often be “gas-lifted” back into production using coil tubing until the natural oil pressure is sufficient to drive the flow once again. However, the gas lift facilities may not always be available and it is expensive and time-consuming to rig up temporary facilities.

If continuous injection facilities are available, the inhibitor compound may be applied continuously to the production stream. However, such facilities are not always feasible and are only available in relatively modern wells.

It is only now, with the advent of more advanced techniques for analyzing the process of oil extraction that the problems set out above have been appreciated. There thus exists a great need for a method of inhibiting oil scale formation that does not suffer from the disadvantages that beset conventional techniques.

Furthermore, in offshore natural gas production systems, alcohols such as methanol or ethylene glycol are often introduced into the well, well head or flow line to prevent formation of hydrates which can cause plugging problems in the same manner as scale deposition. When gas/condensate production occurs remotely from a platform via a sub-sea flow line, conventionally, chemical injection at the wellhead or downhole is supplied by an umbilical connector in which are contained a bundle of lines. It is necessary to supply scale inhibitor in a separate line because traditional scale inhibitors are generally intolerant of alcohols, to the extent that mixing of the two types of chemical causes severe precipitation problems with the scale inhibitor. However, each line is extremely costly. Accordingly, a scale inhibitor composition that is compatible with both traditional oilfield treatment chemicals and other aqueous-based solvent packages is particularly useful, since it avoids the necessity to supply the scale inhibitor separately.

Suitable additives for scale control, also referred to herein as scale inhibitors, which are useful in the compositions of the present disclosure include, without limitation, chelating agents, e.g., Na, K or NH₄⁺ salts of EDTA; Na, K or NH₄⁺ salts of NTA; Na, K or NH₄⁺ salts of erythorbic acid; Na, K or NH₄⁺ salts of thioglycolic acid (TGA); Na, K or NH₄⁺ salts of hydroxy acetic acid; Na, K or NH₄⁺ salts of citric acid; Na, K or NH₄⁺ salts of tartaric acid or other similar salts or mixtures or combinations thereof. Suitable additives that work on threshold effects, such as sequestrants, include, without limitation: phosphates, e.g., sodium hexamethylphosphate, linear phosphate salts, salts of polyphosphoric acid, phosphonates, e.g., nonionic phosphonates such as HEDP (hydroxythylidene diphosphoric acid), PBTC (phosphoisobutane, tricarboxylic acid), amino phosphonates of: MEA (monoethanolamine), NH₃, EDA (ethylene diamine), bis-hydroxyethylene diamine, bis-aminoethylether, DETA (diethylenetriamine), HMDA (hexamethylenediamine), hyper-homologues and isomers of HMDA, polyamines of EDA and DETA, diglycolamine and homologues thereof, or similar polyamines or mixtures or combinations thereof; phosphate esters, e.g., polyphosphoric acid esters or phosphorus pentoxide (P₂O₅) esters of: alkanol amines such as MEA, DEA, triethanolamine (TEA), bis-hydroxyethylethylene diamine; ethoxylated alcohols, glycerin, glycols such as EG (ethylene glycol), propylene glycol, butylene glycol, hexylene glycol, trimethylol propane, pentaeryithrol, neopentyl glycol or the like; tris- and tetra-hydroxy amines; ethoxylated alkyl phenols (limited use due to toxicity problems), ethoxylated amines such as monoamines like MDEA and higher amines from 2 to 24 carbons atoms, diamines 2 to 24 carbons carbon atoms, or the like; polymers, e.g., homopolymers of aspartic acid, soluble homopolymers of acrylic acid, copolymers of acrylic acid and methacrylic acid, terpolymers of acylates, AMPS, etc., hydrolyzed polyacrylamides, poly malic anhydride (PMA); or the like; or mixtures or combinations thereof, as well as salts, such as the calcium, sodium, or potassium salts thereof.

In accordance with certain aspects of the present disclosure, the scale inhibitor is or includes a compound that inhibits the formation of carbonate, sulfate, or phosphate scales. Such scale inhibitors may include one or more compounds represented by at least one of the following general structures (I), (II), or (III):

R—N(OH)-Aₙ-P(O)—(OH)₂ (I)

wherein R is an alkyl, alkenyl, alkynyl, acyl, or aryl group, which may be substituted or unsubstituted, branched or unbranched;
A is an alkyl, alkenyl, alkynyl, acyl, or aryl group having from 1 to 20 carbon atoms, and which may be substituted or unsubstituted, branched or unbranched; and n is an integer from 0 to 20;
or

R₁—N(R₂)-Aₙ-P(O)—(OH)₂ (II)

wherein A is an alkyl, alkenyl, alkynyl, acyl, or aryl group having from 1 to 20 carbon atoms, and which may be substituted or unsubstituted, branched or unbranched, including at least one methylene functional group;
n is an integer from 0 to 20;
wherein R₁ is an alkyl, alkenyl, acyl, carbonyl, or aryl group, which may be substituted or unsubstituted, branched or unbranched; and
wherein R₂ is an alkyl, alkenyl, alkynyl, acyl, carbonyl, or aryl group, which may be substituted or unsubstituted, branched or unbranched;
or,

R₃—N(R₄)-Aₙ-O—P(O)—(OH)₂ (III)

wherein A is an alkyl, alkenyl, alkynyl, acyl, or aryl group having from 1 to 20 carbon atoms, and which may be substituted or unsubstituted, branched or unbranched;
n is an integer from 0 to 20;
wherein R₃ is an alkyl, alkenyl, acyl, carbonyl, or aryl group, which may be substituted or unsubstituted, branched or unbranched; and
wherein R₄ is an alkyl, alkenyl, acyl, carbonyl, or aryl group, which may be substituted or unsubstituted, branched or unbranched.

Examples of compounds which fall within these groups of compounds include EDTMPA, HEDP, A™P, TEA (triethylamine) phosphate ester, DETA phosphonate, BHMT phosphonate, as well as anionic scale inhibitors, such as the ammonium or sodium salt of a hydroxylamino phosphonic acid.

Examples of additional scale inhibitors that are suitable for use in the compositions of the present invention include, hexamethylene diamine tetrakis (methylene phosphonic acid), diethylenetriamine tetra (methylene phosphonic acid), diethylenetriamine penta (methylene phosphonic acid), bis-hexamethylene triamine pentakis (methylene phosphonic acid), polyacrylic acid (PAA), phosphino carboxylic acid (PPCA) iglycol amine phosphonate (DGA phosphonate); 1-hydroxyethylidene 1,1-diphosphonate (HEDP phosphonate); bis-aminoethylether phosphonate (BAEE phosphonate) and polymers of sulphonic acid on a polycarboxylic acid backbone.

In accordance with a further aspect of the present disclosure, the inventive well treatment compositions achieve scale control by the use of two separate, synergistic components—chelants and sequestrants. While either chelant or sequestrant chemistry can achieve scale control independently, unexpected synergistic results may be achieved with a unique combination of components, and thus a combination of at least one chelant and one sequestrant is preferred.

Chelants work by combining with metals including transition metal radical ions such as iron, copper, and manganese, and water hardness ions such as calcium and magnesium, to form a complex known as a chelant, which keeps the iron, copper, manganese, calcium or magnesium cations from interacting with any carbonate (or other) anions that may be present, thus preventing scale formation and formation damage. They also prevent metals such as zinc, copper or iron from depositing on a tool or pipe surface where they could cause flow blockage or corrosion. On the other hand, sequestrants work in a different manner. Sequestrants do not prevent the formation of iron, calcium or magnesium carbonate. Rather, they interact with small iron, calcium and magnesium carbonate particles, preventing them from aggregating into a hard scale deposit. The particles repel each other and remain suspended in the water, or form loose aggregates which may settle. These loose aggregates are easily rinsed away and will not form a deposit.

Useful sequestrants for the inventive compositions may include sodium polyaspartate (Baypure® DS 100); sodium carboxymethyl inulin with carboxylate substitution degrees (DS) of 2.5 (e.g., Dequest® SPE 15625); aminotri-methylene phosphonate (e.g., Dequest® 2006); polyacrylic acid; and GLDA (glutamic acid, N,N-diacetic acid, tetrasodium salt (e.g., Dissolvine GL45-S). Exemplary preferred sequestrants include but are not limited to aminotrimethylene phosphonate and polyacrylic acid. Preferably, combinations of preferred sequestrants are used.

Chelants are also used for scale control. The chelants selected for use in the claimed invention may include methyl glycine diacetic acid (MGDA, available as Trilon® M), sodium glucoheptonate (Burco BSGH400), disodium hydroxymethyl-iminodiacetic acid (XUS 40855.01), imino disuccinic acid (Baypure® CX 100/34 or Baypure® CX 100 Solid G), EDDS ([S,S]-ethylenediamine-N,N′-disuccinic acid) (Octaquest® A65 or Octaquest® E30, both available form The Associated Octel Company Limited, U.K.), citric acid, glycolic acid and lactic acid. A preferred chelant is imino disuccinic acid tetrasodium salt. Another preferred chelant is methyl glycine diacetic acid trisodium salt.

Chelants/sequestrants may be present in the inventive composition(s) disclosed herein in amounts ranging from about 5 wt. % to about 50 wt. %, more preferably from about 20 wt. % to about 50 wt. %, and most preferably from about 25 wt. % to about 50 wt. %, based upon the total weight of the composition. More than one chelant/sequestrant may be used, as appropriate and depending upon the particular circumstances of the formation to be treated, and the ranges describe the total amount of chelants/sequestrants in the inventive formulation. In one preferred embodiment, at least two chelant/sequestrant components are utilized to achieve iron control and/or scale inhibition.

Suitable amounts of scale inhibitors, when used alone and without sequestrants, may be included in the treatment fluids of the present disclosure in a range from about 0.2 to about 0.3 gallons per about 1,000 gallons of the treatment fluid. In certain embodiments of the present disclosure, the scale inhibitors, particularly the phosphorus-containing scale inhibitors, can be used in brines having a pH value ranging from about 5.0 to about 9.0, inclusive, wherein at pH ranges outside of this range, the effectiveness of the scale inhibitor(s) within the solution decreases. However, the scale inhibitors that can be used in accordance with aspects of the well treatment fluids of the present invention includes scale inhibitors that can be used at pH values outside of the described pH range suggested above.

Iron Control Agents.

In a number of subterranean formation treating operations, particularly where the treating fluid is acidic (such as the use of a small amount of acid as a pre-flush accompanied by problems linked with the presence of iron in the acid that is pumped into the formations, essentially as a result of the acid dissolving the rust in the casings during pumping, and possibly the dissolving of iron-containing minerals in formation. For example the presence of iron (III) in the injected treating fluid can cause, in contact with certain crude oils, the precipitation of asphaltic products contained in the oil in the form of deposits of a vitreous aspect referred to as “sludges,” which leads to potentially irreversible damage to the treated zone. In the specific case of fracturing operations that include some amount of acid or acidic chemicals, the scale of precipitation generally increases with the strength and concentration of the acid. The dispersibility of customary additives, such as surfactants, can also be affected by the presence of iron (III) through the formation of complexes.

When injected fluids containing acid or having acidic properties is consumed by the dissolution of the minerals of the formation, the presence of iron (III) can lead to the precipitation of a colloidal precipitate of ferric hydroxide, which also damages the formation. In the particular case of wells containing hydrogen sulphide, the ferric hydroxide precipitate does not occur as a reducing medium is typically involved with such wells, but other damaging precipitations, such as that of colloidal sulphur, can also occur in the absence of iron control agents.

Thus, the use of iron control additives is necessary in most well treatments, with a view to removing the majority of the free iron (III) in the treatment fluid.

Suitable iron control agents for use in accordance with the well treatment fluid compositions of the present disclosure include but are not limited to those available from Halliburton Energy Services, Duncan, Okla., and include: “FE-2™” Iron sequestering agent, “FE-2A™” Buffering agent, “FE-3™” Iron control agent, “FE-3A™” Iron control agent, “FE-5A™” Iron control agent, “FERCHEK®” Ferric iron inhibitor, “FERCHEK® A” reducing agent, and “FERCHEK® SC” Iron control system. Other suitable iron control agents include those described in U.S. Pat. Nos. 6,315,045, 6,525,011, 6,534,448, and 6,706,668, the relevant disclosures of which are hereby incorporated by reference.

Other suitable iron control agents suitable for use in accordance with the methods and compositions of the present disclosure include chelating agents, such as TRILON®-B SP (available from BASF, Florham Park, N.J.), an organic chelating agent, as well as other, similar chelating agents, including nitrilotri-acetate (NTA), tetrasodium ethylenediaminetetraacetate (EDTA), HEDTA, and DTPA, preferably EDTA (1-50 wt. %), as well as biodegradable chelating agents such as methyl glycine diacetic acid (MGDA, available as TRILON® M), sodium glucoheptonate (Burco BSGH400), disodium hydroxymethyl-iminodiacetic acid (XUS 40855.01), imino disuccinic acid (Baypure® CX 100/34 or Baypure® CX 100 Solid G), EDDS ([S,S]-ethylenediamine-N,N′-disuccinic acid) (Octaquest® A65 or Octaques®t E30), citric acid, glycolic acid and lactic acid.

Other suitable iron control agents for use with the compositions described herein include a number of organic acids, including ascorbic acid, erythorbic acid, and alkali metal salts thereof, complexing agents of the soluble forms of iron, such as the aminopolycarboxylic acid derivatives, citric acid, acetic acid or salicylic acid, and triethanolamine.

Also suitable for use as iron control agents are those compounds comprising: a sulfur compound selected from the group consisting of sulfur dioxide, sulfurous acid, sulfite salts, bisulfite salts, and mixtures thereof; a source of copper ions; and a source of iodine; wherein the iron control agent is capable of reducing ferric iron containing compounds to ferrous iron containing compounds in an acidic solution that contains a sufficient amount of an acid to dissolve at least a portion of an underground formation.

Further, all known electron donor agents can be used as iron control agents in the compositions of the present disclosure. As used herein and in the appended claims, the term “electron donor agent” means a compound capable of donating one or more electrons to the electron transfer agents. The electron donor agent employed in the inventive well treating composition is preferably soluble in an acid solution and/or the well treating composition itself, selected from the group consisting of (1) a thiol (mercaptan) compound having a carbon chain that includes an oxygen or oxygen containing functional group (e.g., HO—, RO—) in the beta position, (2) hypophosphorous acid (H₃PO₂), and (3) one or more hypophosphorous acid precursors. The use of such electron donor agents in the well treatment compositions of the present disclosure very effectively reduces ferric ion to the innocuous ferrous state in live acid.

The thiol (mercaptan) compound useful as an electron donor agent of the inventive composition is preferably selected from the group consisting of compounds of the formula HSCH₂C(O)R₁ and compounds of the formula HSCH₂C(OH)R₃R₄ wherein: R₁ is either OH, OM or R₂; M is a corresponding cation of the alkoxide or carboxylate anion of the thiol; R₂ is an organic radical (alkyl, alkenyl, alkynyl, or aryl group as defined herein) having from 1 to 6 carbon atoms; R₃ is either H or an organic radical having from 1 to 6 carbon atoms; and R₄ is either H or an organic radical having from 1 to 6 carbon atoms. M is preferably selected from the group consisting of sodium, potassium and ammonium (NH₄).

More preferably, the thiol (mercaptan) compound useful as the electron donor agent of the inventive composition is selected from the group consisting of thioglycolic acid, thioglycolic acid precursors, β-hydroxymercaptans, thiomalic acid and thiolactic acid. Suitable compounds include but are not limited to: thioglycolic acid, α-methylthioglycolic acid, methylthioglycolate, α-phenylthioglycolic acid, methyl-α-methylthioglycolate, benzylthioglycolate, α-benzylthioglycolic acid, ammonium thioglycolate, calcium dithioglycolate, β-thiopropionic acid, methyl-β-thiopropionate, sodium-β-thiopropionate, 3-mercapto-1,2-propanediol, thiomalic (mercaptosuccinic) acid, thiolactic acid and mercaptoethanol. Thioglycolic acid is also suitable for use herein.

In another embodiment of the present disclosure, the electron donor agent of the inventive well treating composition is hypophosphorous acid (also called phosphinic acid) (H₃PO₂) and/or one or more hypophosphorous acid precursors (i.e., a compound capable of producing hypophosphorous acid in aqueous acidic media). A non-limiting example of a hypophosphorous acid precursor is a hypophosphorous acid salt. Hypophosphorous acid salts ionize in the aqueous acid solution and are protonated thus forming hypophosphorous acid. Suitable hypophosphorous salts include sodium phosphinate, calcium phosphinate, ammonium phosphinate and potassium phosphinate. Using hypophosphorous acid and/or one or more salts thereof as the electron donor agent is advantageous in that hypophosphorous acid and its salts are not as corrosive as other reducing agents and are better suited for high temperature applications.

The electron donor agent of the inventive well treating fluid composition preferably operates in conjunction with electron transfer agents to result in the reduction of all of the ferric ion in the treating solution to an innocuous ferrous ion. The amount of the electron donor agent required to do this is dependent upon the molecular weight of the particular electron donor agent employed. The electron production resulting from use of the electron donor agent is quantitative; that is, all of the electron donor agent is consumed (oxidized). Thus, the reaction is stoichiometric. This means that the quantity of the electron donor agent required will be a function of its molecular weight as well as how much ferric iron (Fe(III)) needs to be reduced.

Non-Emulsifiers.

In some implementations of the compositions of the present invention, it is desired to treat or to precondition the reservoir with a demulsification agent to reduce or eliminate costly “oil-in-water”, “water-in-oil”, or similar emulsion formation during hydrocarbon production or recovery operations, which can ultimately result in plugging or similar undesirable effects in or around the reservoir (e.g., emulsion formation which can exhibit high viscosity and/or can impede the flow of formation or production fluids to or from the wellbore). As used herein, the term “oil-in-water emulsion” is used generically to refer to a mixture of two immiscible phases wherein an oil (dispersed phase) is dispersed in an aqueous solution (the continuous phase), while the term “water-in-oil emulsion” is used generically to refer to a mixture of immiscible fluid phases wherein water (dispersed phase) is dispersed in an oil or similar hydrocarbon (the continuous phase). Alternatively, or equivalently, the compositions of the present disclosure may be used to stabilize dispersions and emulsions. As used herein the term “emulsion formation” refers to a fluid separation that results in a distinct water or aqueous layer at the lowest vessel level; a distinct oil layer at the uppermost vessel level; and an interface between the two which constitutes an emulsion, i.e., a dispersion of oil and water droplets, often with one component predominating as a continuous phase, and the other phase predominating as a discontinuous phase. This emulsion layer is often alternatively referred to as the “rag layer”. As will be understood by those in the field, it is desirable to ensure that the emulsion layer remain in the free water knock-out where it cannot contaminate either of the recovered oil or water products. In accordance with aspects of the present disclosure, the compositions of the present invention can control emulsion formation in a formation or production fluid.

Various additives may be incorporated into the well treatment fluids described herein as non-emulsifiers or emulsifier inhibitors (alternatively referred to as demulsifiers). Specific, non-limiting examples include, but are not necessarily limited to, ethoxylated alkyl phenols, alkyl benzyl sulfonates, xylene sulfonates, alkyloxylated surfactants, ethoxylated alcohols, surfactants and resins, and phosphate esters. Oxyalkyl polyols can also be advantageously employed as non-emulsifiers in accordance with aspects of the present disclosure.

Further, certain additives are known which, by themselves, do not act as emulsifiers, but instead act as preconditioning agents, or act to enhance the performance of the non-emulsifiers (or, “demulsifiers”), can be included in the well treatment fluid compositions of the present disclosure. Various non-emulsifier enhancers include, but are not necessarily limited to alcohol, glycol ethers, polyglycols, aminocarboxylic acids and their salts, bisulfites, polyaspartates, aromatics and mixtures thereof. Biodegradable non-emulsifier enhancers may also be used, and include, but are not necessarily limited to, chelants such as polyaspartate, disodium hydroxyethyliminodiacetic (Na₂HEIDA), sodium gluconate; sodium glucoheptonate, glycerol, iminodisuccinates, and mixtures thereof. Preconditioning agents can also be used, in conjunction with the non-emulsifiers “demulsifiers”, including but not limited to water soluble alcohols and water soluble polyoxyalkylene-based compounds.

Clay Stabilizers.

Yet another component that can be included in the treating fluid compositions of the present disclosure is a clay stabilizer. Examples of suitable clay stabilizers which can be used in the compositions of the present disclosure include, but are not limited to, potassium chloride, sodium chloride, ammonium chloride, tetramethyl ammonium chloride and the like. Examples of some temporary clay stabilizers that are suitable for use in the treatment fluid compositions of the present disclosure are also disclosed in, for example, U.S. Pat. Nos. 5,197,544; 5,097,904; 4,977,962; 4,974,678; 4,828,726, the entire disclosures of which are incorporated herein by reference. Of these, potassium chloride and tetramethyl ammonium chloride are preferred for use as clay stabilizers. When used, the clay stabilizer is included in the treating fluid composition in an amount in the range of from about 0.1% to about 20% by weight of the water therein, and more preferably from about 0.5% to about 10% by weight of the water in the composition.

Polymer Breakers.

A final component which may be included in the treating fluid compositions of the present disclosure is a breaker or crosslink de-linker for causing the fluid to quickly revert to a thin fluid. Examples of suitable breakers or de-linkers include, but are not limited to, a delayed breaker or de-linker capable of lowering the pH of the treating fluid to cause the polymer crosslink to reverse, thereby reducing the viscosity of the treating fluid at a desired time. Examples of suitable delayed or controlled breakers or de-linkers which can be utilized in accordance with the present disclosure include, but are not limited to, various lactones, esters, encapsulated acids and slowly soluble acid generating compounds, oxidizers which produce acids upon reaction with water, water reactive metals such as aluminum, lithium and magnesium and the like. Examples of exemplary oxidizers include but are not limited to sodium chlorite, hypochlorites, perborates, persulfates, peroxides (including organic peroxides), enzymes, derivatives thereof, and combinations thereof. Examples of peroxides that may be suitable include tert-butyl hydroperoxide and tert-amyl hydroperoxide. Of these, the esters are preferred. Alternatively, any of the conventionally used breakers employed with metal ion crosslinkers can be utilized such as, for example, sodium chlorite, sodium bromate, sodium persulfate, ammonium persulfate, encapsulated sodium persulfate, potassium persulfate, or ammonium persulfate and the like as well as magnesium or calcium peroxide. Enzymatic breakers that may be employed include alpha and beta amylases, amyloglucosidase, invertase, maltase, cellulase and hemicellulase, as well as combinations thereof. The breaker or de-linker may be included in the treating fluid compositions described herein in an amount in the range of from about 0% to about 5% by weight of water in the composition, inclusive, and more preferably in an amount ranging from about 0% to about 2% by weight of water in the composition, inclusive.

Optionally, biodegradable colorants or dyes may be used in the fracturing fluid compositions of this invention to help identify them and distinguish them from other fluids used in hydrocarbon recovery.

The following examples are included to demonstrate preferred embodiments of the invention. It should be appreciated by those of skill in the art that the techniques disclosed in the examples which follow represent techniques discovered by the inventor(s) to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention.

None of the examples are intended, nor should they be construed, to limit the invention as otherwise described and claimed herein. All numerical values are approximate, regardless of whether the word “about” or “approximate” is used in describing the numerical values. Numerical ranges, if given, are merely exemplary. Embodiments outside the given numerical ranges can nevertheless fall within the scope of the invention as claimed.

### EXAMPLES

### Example 1

### Scale Inhibitor Formulation

A simulated fracturing fluid brine containing a crosslinking additive and a scale inhibitor was prepared by first mixing a 2% KCl base solution (2.0 g of KCl in 100.0 mL of water), and to this adding 10.0 mL of a crosslinking additive solution containing 226.49 mL of ulexite brine, 4.6 g of KCl, 8.0 g of Acti-Gel® 208 an attapulgite clay (available from Active Minerals International, LLC, Quincy, Fla.), 2.0 g of STAFLO® Exlo and 0.25 g of STAFLO® Regular, low and high viscosity polyanionic cellulose (available from Akzo-Nobel, The Netherlands), 23.33 mL of Inhibisal Ultra® SI-141 an anionic scale inhibitor (available from TBC-Brinadd, Houston, Tex.), 1 mL of NaOH, 1.75 mL of Bactron K-54, a biocide (available from Champion Technologies, Houston, Tex.), 174.9 g of ulexite (available from American Borate Company, Virginia Beach, Va.) having a D₅₀ of 11 microns, and 3.2 mL of Nalco 9762 as a deflocculant (available from Nalco Energy Services, L.P., Sugar Land, Tex.). The ratios of percent-by-weight of these additives in the crosslinking additive solution are shown in Table A. The sample was then filtered through API filter paper at ambient temperature at 250 psi pressure (Table B). Thereafter, the simulated treating fluid brine containing a combination crosslinking agent and scale inhibitor was subjected to calcium carbonate and calcium sulfate precipitation tests, as detailed in Tables C-D.

TABLE A
Percent by Weight Calculations

| | | | | | Density, | Weight, | Weight, |
|---|---|---|---|---|---|---|---|
| | 350 mL | | 42 gal | | lb/gal | lb | % |
| Ulexite Brine | 226.49 | mL | 27.18 | gal | 8.34 | 226.68 | 50.75 |
| KCl | 4.6 | g | 4.6 | lb | — | 4.6 | 1.03 |
| Actigel 208 | 8.0 | g | 8.0 | lb | — | 8.0 | 1.79 |
| Staflo Exlo | 2.0 | g | 2.0 | lb | — | 2.0 | 0.45 |
| Staflo Regular | 0.25 | g | 0.25 | lb | — | 0.25 | 0.06 |
| Inhibisal Ultra | 23.33 | mL | 2.80 | gal | 8.20 | 22.96 | 5.14 |
| SI-141 | | | | | | | |
| NaOH | 1.0 | mL | 0.12 | gal | 10.16 | 1.23 | 0.28 |
| Bactron K-54 | 1.75 | mL | 0.21 | gal | 9.42 | 1.98 | 0.44 |
| Ulexite | 174.9 | g | 174.9 | lb | — | 174.9 | 39.16 |
| Nalco 9762 | 3.2 | mL | 0.38 | gal | 10.7 | 4.07 | 0.91 |

| | | | | | |
|---|---|---|---|---|---|
| Total | — | — | — | 446.67 | 100.01 |

### Scale Inhibitor Tests

TABLE B
Simulated Fracturing Fluid with 3.0 gal/1,000 gal of Crosslinking
Additive Containing 0.2 gal/1,000 gal of Scale Inhibitor

| | |
|---|---|
| 1 | Prepare a 2% KCl solution with 2.0 g of KCl mixed in 100.0 mL |
| | of water |
| 2 | Add 10.0 mL of crosslinking additive containing a scale |
| | inhibitor (Table A) |
| 3 | Filter sample at 250 psi through API filter paper at ambient |
| | temperature |

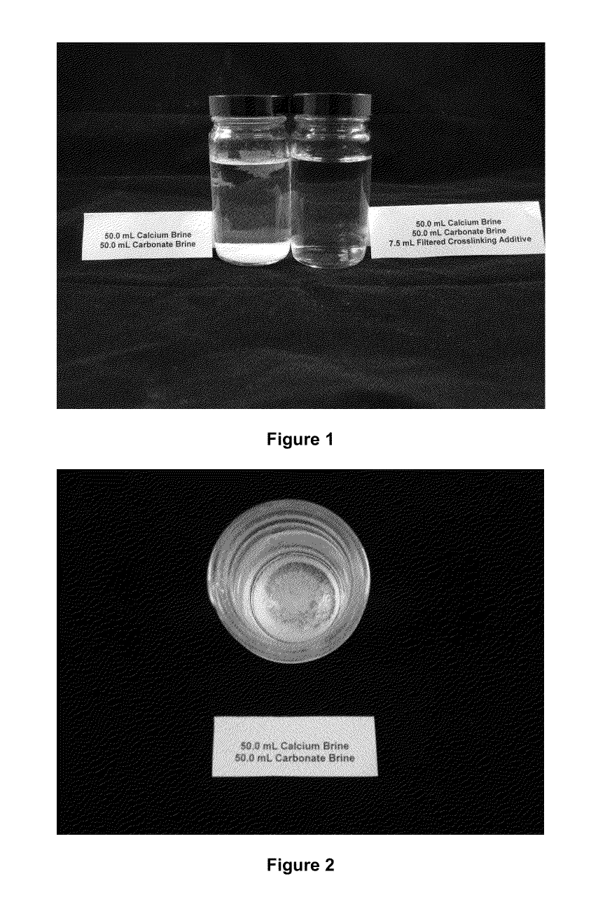

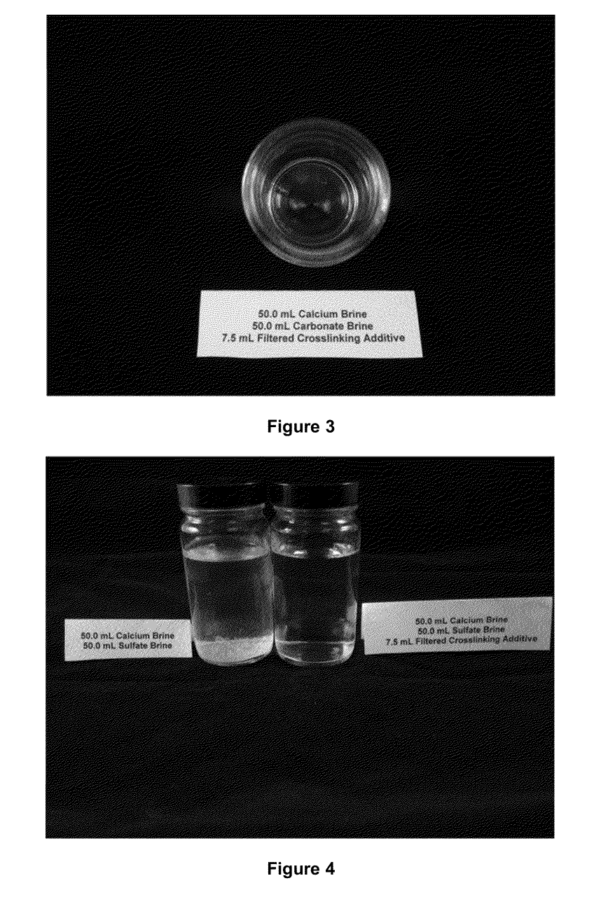

TABLE C
Calcium Carbonate¹ Precipitation Test

| | |
|---|---|
| 1 | Prepare calcium brine with 1 liter of distilled water, 3.68 g/L |
| | MgCl₂•6H₂O, 12.15 g/L CaCl₂•2H₂O, and 33.0 g/L NaOH |
| 2 | Prepare carbonate brine with 1 liter of distilled water, |
| | 7.36 g/L NaHCO₃, and 33.0 g/L NaCl |
| 3 | Adjust pH of brines to 10 with NaOH |
| 4 | Mix a blank sample with 50.0 mL of calcium brine and 50.0 mL |
| | of carbonate brine in an 8 oz glass jar |
| 5 | Mix a second sample with 50.0 mL of calcium brine, 50.0 mL of |
| | carbonate brine, and 7.5 mL of filtered crosslinking additive |
| | containing scale inhibitor |
| 6 | Place samples in oven at 160° F. for 24 hours, remove from |
| | oven and record visual observations (FIGS. 1, 2 and 3) |

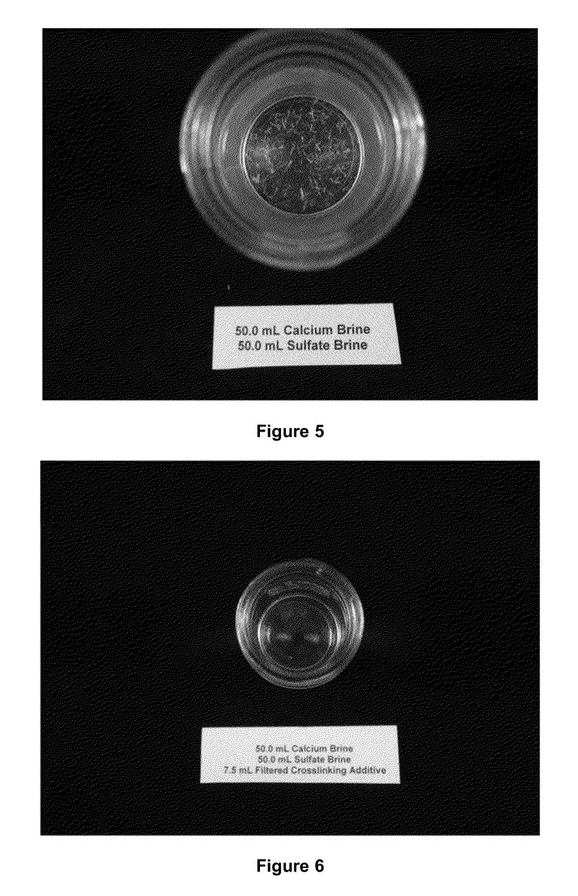

TABLE D
Calcium Sulfate¹ Precipitation Test

| | |
|---|---|
| 1 | Prepare calcium brine with 1 liter of distilled water, 7.5 g/L |
| | NaCl, and 11.1 g/L of CaCl₂•2H₂O |
| 2 | Prepare sulfate brine with 1 liter of distilled water, 7.5 g/L |
| | NaCl, and 10.66 g/L Na₂SO₄ |
| 3 | Adjust pH of brines to 10 with NaOH |
| 4 | Mix a blank sample with 50.0 mL of calcium brine and 50.0 mL |
| | of sulfate brine in an 8 oz glass jar |
| 5 | Mix a second sample with 50.0 mL of calcium brine, 50.0 mL of |
| | sulfate brine, and 7.5 mL of filtered crosslinking additive |
| | containing scale inhibitor |
| 6 | Place samples in oven at 160° F. for 24 hours, remove from oven |
| | and record visual observations (FIGS. 4, 5 and 6) |

¹Calcium, carbonate, and sulfate brines are made with American Chemical Society (ACS) grade chemicals.

FIGS. 1-6 illustrate the effectiveness of the compositions of the present disclosure, undergoing these tests with scale inhibition within the aqueous system being maintained at a percent of inhibition greater than about 50%, preferably greater than about 55%, and more preferably greater than about 60%.

### Example 2

### Scale Inhibitor, Non-Emulsifier, and Iron Control Formulation

A simulated fracturing fluid brine containing a crosslinking additive, a scale inhibitor, a non-emulsifier, and an iron control agent was prepared by first mixing a 2 KCl base solution (2.0 g of KCl in 100.0 mL of water), and to this adding 10.0 mL of a crosslinking additive solution containing 114.62 mL of ulexite brine, 61.36 mL of KCO₂H, 8.0 g of Acti-Gel® 208 an attapulgite clay (available from Active Minerals International, LLC, Quincy, Fla.), 14.58 mL of Inhibisal Ultra SI-141 an anionic scale inhibitor (available from TBC-Brinadd, Houston, Tex.), 72.92 mL of Fracsal NE-160 a non-emulsifier (available from TBC-Brinadd, Houston, Tex.), 146.71 g of TRILON®-B SP a chelating agent (available from BASF, Florham Park, N.J.), 43.75 g of ulexite (available from American Borate Company, Virginia Beach, Va.) having a D₅₀ of 15 microns, and 3.0 mL of Nalco 9762 as a deflocculant (available from Nalco Energy Services, L.P., Sugar Land, Tex.). The ratios of percent-by-weight of these additives in the crosslinking additive solution are shown in Table E. The sample was then filtered through API filter paper at ambient temperature at 250 psi pressure (Table F). Thereafter, the simulated treating fluid brine containing a combination crosslinking agent, scale inhibitor, non-emulsifier, and iron control agent was subjected to calcium carbonate/calcium sulfate precipitation tests, as well as, non-emulsifier and iron control tests, as detailed in Tables G-K. The performance of the exemplary compositions described for scale inhibition (e.g., calcium carbonate or calcium sulfate scale inhibition) may also be measured using the protocols described in NACE test method TM0374-2007. The ability and performance of the compositions of the present disclosure to inhibit precipitation of barium sulfate, strontium sulfate, or both, from a solution or system (e.g., from an oilfield brine or oilfield fluid system) can be measured using the protocols described in NACE test method TM0197-2010, the contents of which are incorporated herein by reference. The performance of the exemplary compositions of the disclosure for emulsion control (non-emulsifiers) can be measured using the protocols described herein, or using the protocols set forth in DIN 51415 and/or ASTM D 1094. Thus, the instant compositions may be described as having the ability to control emulsion formation in a production or formation fluid, alone or in combination with scale control and/or iron control.

TABLE E
Percent by Weight Calculations

| | | | | | Density, | Weight, | Weight, |
|---|---|---|---|---|---|---|---|
| | 350 mL | | 42 gal | | lb/gal | lb | % |
| Ulexite Brine | 114.62 | mL | 13.75 | gal | 8.34 | 114.68 | 22.84 |
| KCOOH | 61.36 | mL | 7.36 | gal | 13.1 | 96.42 | 19.21 |
| Actigel 208 | 8.0 | g | 8.0 | lb | — | 8.0 | 1.59 |
| Inhibisal Ultra | 14.58 | mL | 1.75 | gal | 8.2 | 14.35 | 2.86 |
| SI-141 | | | | | | | |
| Fracsal NE-160 | 72.92 | mL | 8.75 | gal | 8.49 | 74.29 | 14.80 |
| Trilon-B SP | 146.71 | g | 146.71 | lb | — | 146.71 | 29.22 |
| Ulexite | 43.75 | g | 43.75 | lb | — | 43.75 | 8.71 |
| Nalco 9762 | 3.0 | mL | 0.36 | gal | 10.7 | 3.85 | 0.77 |

| | | | | | |
|---|---|---|---|---|---|
| Total | — | — | — | 502.05 | 100.00 |

### Scale Inhibitor, Non-Emulsifer, and Iron Control Tests

TABLE F
Simulated Fracturing Fluid with 4.8 gal/1,000 gal of
Crosslinking Additive Containing 0.2 gal/1,000 gal
of Scale Inhibitor, 1.0 gal/1,000 gal of Non-Emulsifier,
and 2.0 lb/1,000 gal of Iron Control Agent

| | |
|---|---|
| 1 | Prepare a 2% KCl solution with 2.0 g of KCl mixed in 100.0 mL |
| | of water |
| 2 | Add 10.0 mL of crosslinking additive containing a scale |
| | inhibitor, non-emulsifier, and iron control agent (Table E) |
| 3 | Filter sample at 250 psi through API filter paper at ambient |
| | temperature |

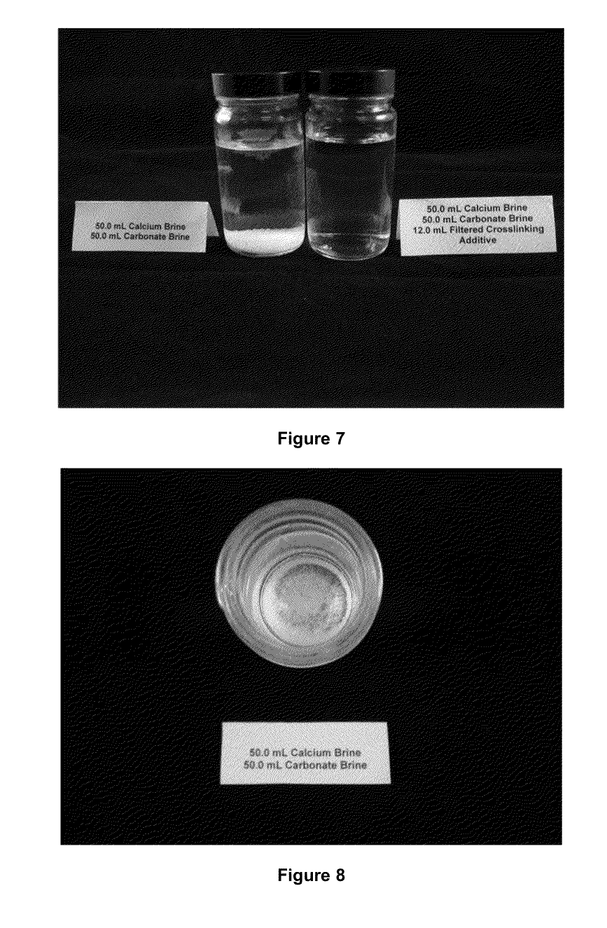

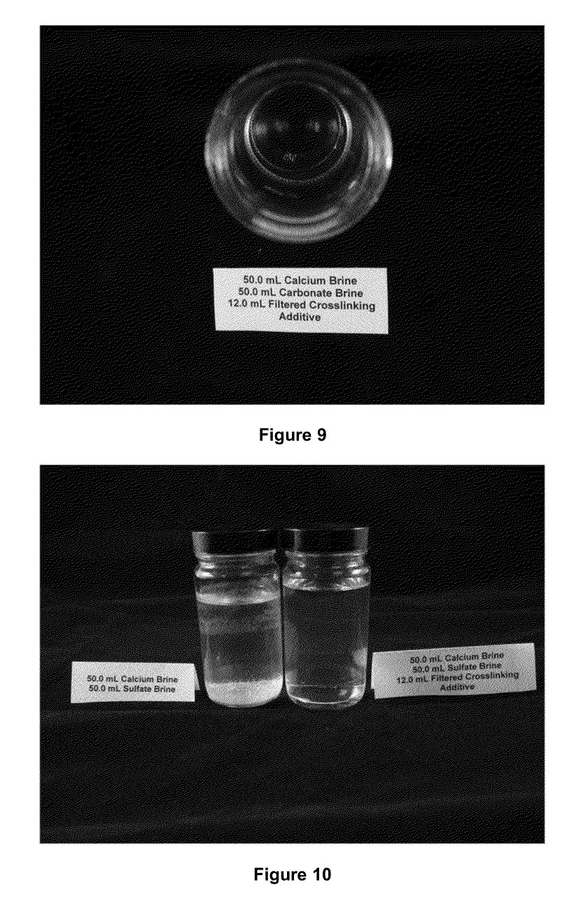

TABLE G
Calcium Carbonate² Precipitation Test

| | |
|---|---|
| 1 | Prepare calcium brine with 1 liter of distilled water, 3.68 g/L |
| | MgCl₂•6H₂O, 12.15 g/L CaCl₂•2H2O, and 33.0 g/L NaOH |
| 2 | Prepare carbonate brine with 1 liter of distilled water, |
| | 7.36 g/L NaHCO₃, and 33.0 g/L NaCl |
| 3 | Saturate both brines with CO₂ at a rate of 250 mL/minute for |
| | 30 minutes |
| 4 | Mix a blank sample with 50.0 mL of calcium brine and 50.0 mL of |
| | carbonate brine in an 8 oz glass jar |
| 5 | Mix a second sample with 50.0 mL of calcium brine, 50.0 mL of |
| | carbonate brine, and 12.0 mL of filtered crosslinking additive |
| | containing scale inhibitor, non-emulsifier, and iron control |
| | agent |
| 6 | Place samples in oven at 160° F. for 24 hours, remove from oven |
| | and record visual observations (FIGS. 7, 8 and 9) |

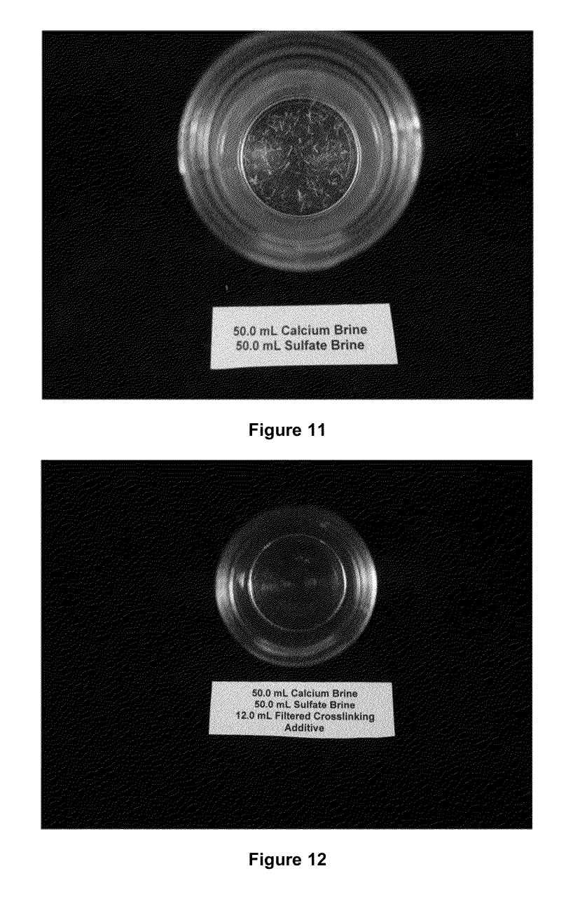

TABLE H
Calcium Sulfate² Precipitation Test

| | |
|---|---|
| 1 | Prepare calcium brine with 1 liter of distilled water, 7.5 g/L |
| | NaCl, and 11.1 g/L of CaCl₂•2H₂O |
| 2 | Prepare sulfate brine with 1 liter of distilled water, 7.5 g/L |
| | NaCl, and 10.66 g/L Na₂SO₄ |
| 3 | Mix a blank sample with 50.0 mL of calcium brine and 50.0 mL of |
| | sulfate brine in an 8 oz glass jar |
| 4 | Mix a second sample with 50.0 mL of calcium brine, 50.0 mL of |
| | sulfate brine, and 12.0 mL of filtered crosslinking additive |
| | containing scale inhibitor, non-emulsifier, and iron control |
| | agent |
| 5 | Place samples in oven at 160° F. for 24 hours, remove from oven |
| | and record visual observations (FIGS. 10, 11 and 12) |

²Calcium, carbonate, and sulfate brines are made with American Chemical Society (ACS) grade chemicals.

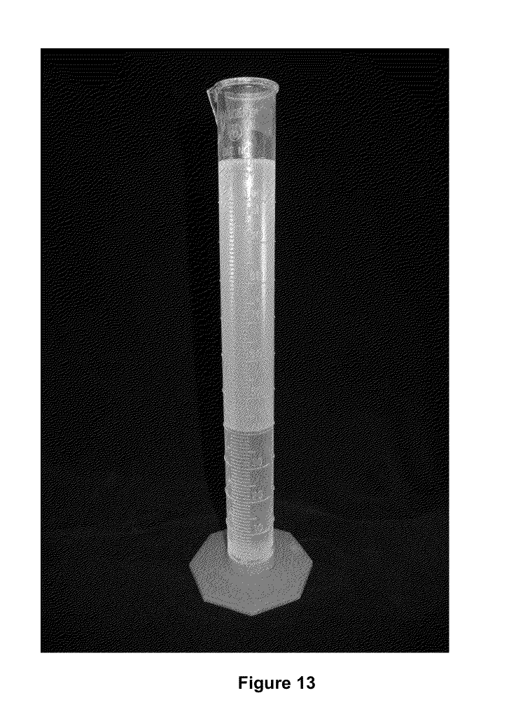

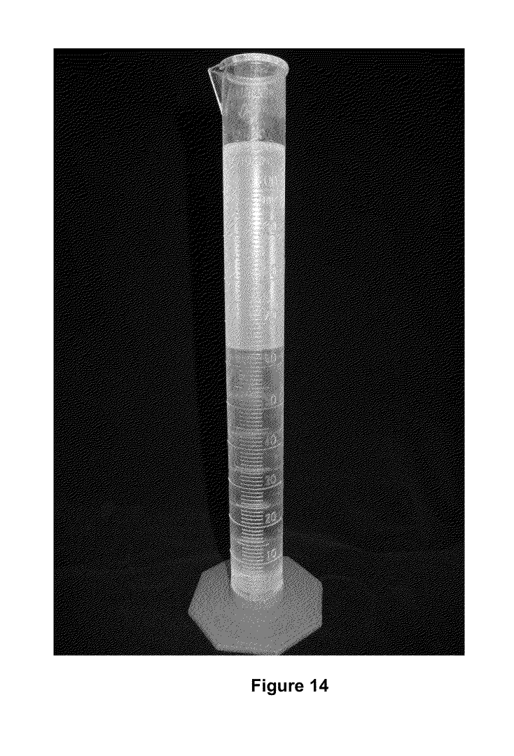

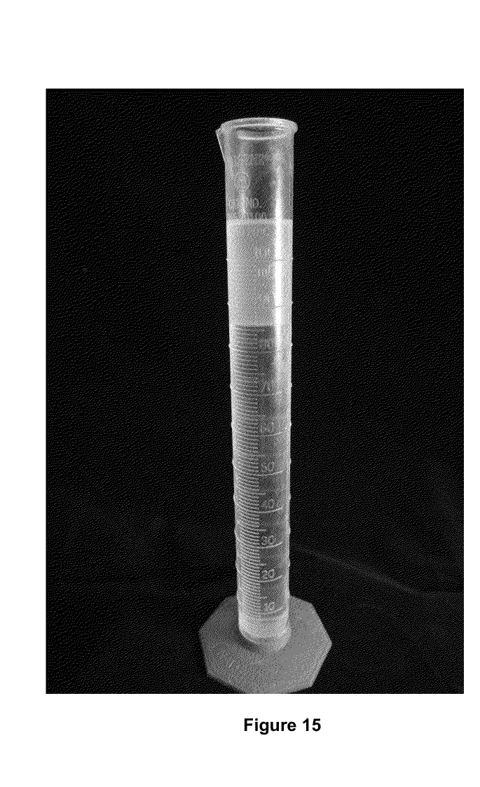

TABLE I
Non-Emulsifier Test

| | |
|---|---|
| 1 | Prepare a 2% KCl solution with 2.0 g of KCl mixed in 100.0 mL |
| | of water |
| 2 | Add 10.0 mL of crosslinking additive containing a scale |
| | inhibitor, non-emulsifier, and iron control agent (Table E) |
| 3 | Filter sample at 250 psi through API filter paper at ambient |
| | temperature |
| 4 | Place 25.0 mL, 50.0 mL, and 75.0 mL of 10.0 lb/gal NaCl brine |
| | in 100.0 mL graduated cylinders |
| 5 | Add diesel to each graduated cylinder to reach the 100.0 mL |
| | mark |
| 6 | Add 12.0 mL of filtered crosslinking additive containing |
| | scale inhibitor, non-emulsifier, and iron control agent to |
| | each sample |
| 7 | Place a cork in the opening and shake vigorously 100 times |
| 8 | Place on a flat surface and record the time required for the |
| | brine and diesel to separate (Table J) (FIGS. 13, 14 and 15) |

TABLE J
Brine/Diesel Separation Times

| | Separation Time, |
|---|---|
| Composition | min:sec² |
| 25.0 mL NaCl Brine (10.0 lb/gal) | 4:57 |
| 75.0 mL Diesel | |
| 12.0 mL Filtered Sample¹ | |
| 50.0 mL NaCl Brine (10.0 lb/gal) | 5:54 |
| 50.0 mL Diesel | |
| 12.0 mL Filtered Sample | |
| 75.0 mL NaCl Brine (10.0 lb/gal) | 4:19 |
| 25.0 mL Diesel | |
| 12.0 mL Filtered Sample | |

¹Filtered sample contains scale inhibitor, non-emulsifier, and iron control agent.
²Acceptable separation times are below 10 minutes.

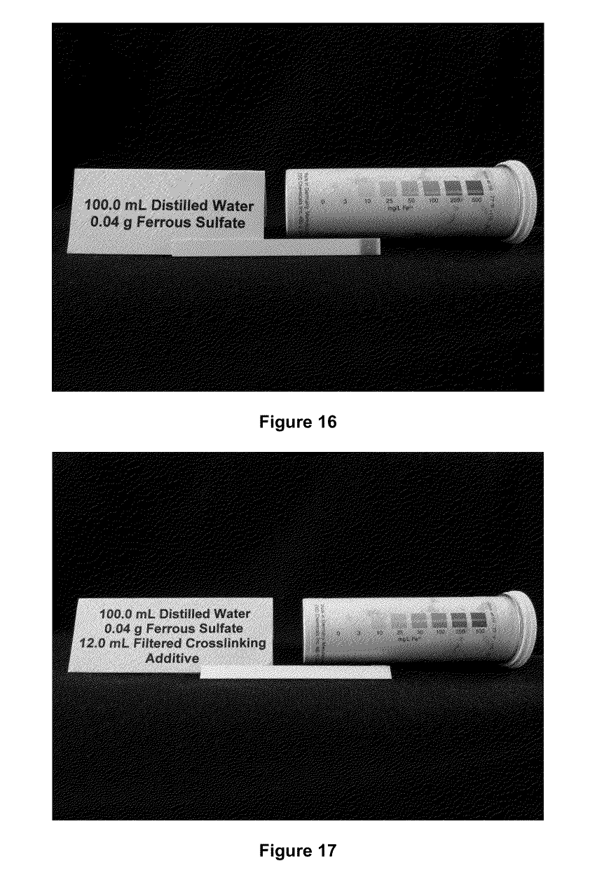

TABLE K
Iron Control Agent Test¹

| | |
|---|---|
| 1 | Prepare a 2% KCl solution with 2.0 g of KCl mixed in 100.0 mL |
| | of water |
| 2 | Mix a sample with 10.0 mL of crosslinking additive containing |
| | a scale inhibitor, non-emulsifier, and iron control agent |
| | (Table E) in 100.0 mL of 2% KCl |
| 3 | Filter sample at 250 psi through API filter paper at ambient |
| | temperature |
| 4 | Prepare ferrous sulfate brine with 100.0 mL of distilled |
| | water and 0.04 g of ferrous sulfate |
| 5 | Immerse iron test strip briefly into ferrous sulfate brine |
| 6 | Shake to remove excess water |
| 7 | Compare color of wet strip to colorimetric chart (FIG. 16) |
| 8 | Record total dissolved iron (250.0 mg/L) |
| 9 | Add 12.0 mL of filtered crosslinking additive containing |
| | scale inhibitor, non-emulsifier, and iron control agent |
| 10 | Shake sample vigorously, then place on a flat surface for |
| | 15 minutes |
| 11 | Immerse iron test strip briefly into ferrous sulfate brine |
| 12 | Shake to remove excess water |
| 13 | Compare color of wet strip to colorimetric chart (FIG. 17) |
| 14 | Record total dissolved iron (in mg/L) |

¹Acceptable level of iron in water is less than 10.0 mg/L.

Other and further embodiments utilizing one or more aspects of the inventions described above can be devised without departing from the spirit of Applicant's invention. Further, the various methods and embodiments of the aspects disclosed herein can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. A well treatment fluid for the treatment of a well penetrating a subterranean formation, the fluid comprising:
an aqueous base fluid;
a gelling agent;
a sparingly-soluble crosslinking agent solution; and
a formation damage prevention agent.

2. The well treatment fluid of claim 1, wherein the base fluid is a brine.

3. The well treatment fluid of claim 1, wherein the formation damage preventing agent is an iron control agent.

4. The well treatment fluid of claim 3, wherein the iron control agent is a chelating agent or a sulfur-containing compound.

5. The well treatment fluid of claim 1, wherein the formation damage preventing agent is a scale inhibitor.

6. The well treatment fluid of claim 5, wherein the scale inhibitor is a phosphorus-containing compound, or an alkali metal or ammonium salt thereof.

7. The well treatment fluid of claim 1, further comprising one or more emulsifier inhibitors.

8. The well treatment fluid of claim 7, wherein the emulsifier inhibitor is selected from the group consisting of ethoxylated alkyl phenols, alkyl benzyl sulfonates, xylene sulfonates, alkyloxylated surfactants, ethoxylated alcohols, surfactants, phosphate esters, and oxyalkyl polyols.

9. The well treatment fluid of claim 7, wherein the emulsifier inhibitor includes a non-emulsifier enhancer.

10. The well treatment fluid of claim 1, further comprising one or more clay stabilizers.

11. The well treatment fluid of claim 10, wherein the clay stabilizer is selected from the group consisting of potassium chloride, sodium chloride, ammonium chloride, tetramethylammonium chloride, and combinations thereof.

12. The well treatment fluid of claim 1, further comprising one or more polymer breakers.

13. A method of treating a subterranean formation, the method comprising:
providing a well treatment fluid during a well treatment operation that comprises an aqueous carrier fluid, a sparingly-soluble crosslinking agent, and one or more formation damage control agents;
injecting the well treatment fluid into a subterranean formation; and
retaining the well treatment fluid within the subterranean formation for a period sufficient to treat the well.

14. The method of claim 13, wherein the treatment operation is one of a fracturing operation, a water flooding operation, a drilling operation, a well bore workover operation, or a gravel packing operation.

15. A process for treating a subterranean formation comprising steps of supplying via a well bore to a subterranean location, an aqueous oilfield fluid comprising an aqueous, viscosifying crosslinked reaction product of a polymer and a crosslinking agent, in combination with one or more formation damage control agents, and
exposing the fluid to conditions at the subterranean location which induce the formation damage control agent to the formation and thereby reduce damage to the formation during hydrocarbon recovery operations,
wherein the formation damage reduced or minimized is scale precipitation, iron formation, and/or “oil-water” emulsion formation.

16. The process of claim 15, wherein the aqueous fluid is used as one of a fracturing fluid, a drilling fluid, a diverting fluid or a gravel packing fluid.
